(19) United States
(12) Patent Application Publication
(10) Pub. No.: US 2011/0075120 A1
(43) Pub. Date: Mar. 31, 2011

(54) EXPOSURE APPARATUS, EXPOSURE METHOD, AND DEVICE MANUFACTURING METHOD

(75) Inventor: Go ICHINOSE, Fukaya-shi (JP)

(73) Assignee: NIKON CORPORATION, Toyko (JP)

(21) Appl. No.: 12/893,075

(22) Filed: Sep. 29, 2010

Related U.S. Application Data
(60) Provisional application No. 61/247,091, filed on Sep. 30, 2009.

(51) Int. Cl. G03B 27/42

(52) U.S. Cl. 355/53; 355/77

(57) ABSTRACT

A wafer stage is driven, based on positional information of a wafer stage measured using a measuring system and tilt information of the wafer stage. This allows the wafer stage to be driven with high precision, with the influence on the wafer stage when the wafer stage is tilted being reduced.

### CROSS-REFERENCE TO RELATED APPLICATIONS

This non-provisional application claims the benefit of Provisional Application No. 61/247,091 filed Sep. 30, 2009, the disclosure of which is hereby incorporated herein by reference in its entirety.

### BACKGROUND OF THE INVENTION

1. Field of the Invention

The present invention relates to exposure apparatuses, exposure methods, and device manufacturing methods, and more particularly to an exposure apparatus and an exposure method in which an object is exposed with an energy beam via an optical system, and a device manufacturing method which uses the exposure apparatus or the exposure method.

2. Description of the Background Art

Conventionally, in a lithography process for manufacturing electron devices (microdevices) such as semiconductor devices (integrated circuits or the like) or liquid crystal display elements, an exposure apparatus such as a projection exposure apparatus by a step-and-repeat method (a so-called stepper), or a projection exposure apparatus by a step-and-scan method (a so-called scanning stepper (which is also called a scanner)) is mainly used.

In these types of exposure apparatuses, the position of a wafer stage which moves holding a substrate (hereinafter generally referred to as a wafer) such as a wafer or a glass plate on which a pattern is transferred and formed, was measured using a laser interferometer in general. However, requirements for a wafer stage position control performance with higher precision are increasing due to finer patterns that accompany higher integration of semiconductor devices recently, and as a consequence, short-term variation of measurement values due to temperature fluctuation and/or the influence of temperature gradient of the atmosphere on the beam path of the laser interferometer can no longer be ignored.

To improve such an inconvenience, various inventions related to an exposure apparatus that has employed an encoder having a measurement resolution at the same level or better than a laser interferometer as the position measuring device of the wafer stage have been proposed (refer to, for example, U.S. Patent Application Publication No. 2008/0088843). However, in the liquid immersion exposure apparatus disclosed in U.S. Patent Application Publication No. 2008/0088843 and the like, there still were points that should have been improved, such as a threat of the wafer stage (a grating installed on the wafer stage upper surface) being deformed when influenced by heat of vaporization and the like when the liquid evaporates.

To improve such an inconvenience, for example, in U.S. Patent Application Publication No. 2008/0094594, as a fifth embodiment, an exposure apparatus is disclosed which is equipped with an encoder system that has a grating arranged on the upper surface of a wafer stage configured by a light transmitting member and measures the displacement of the wafer stage related to the periodic direction of the grating by making a measurement beam from an encoder main body placed below the wafer stage enter the wafer stage and be irradiated on the grating, and by receiving a diffraction light which occurs in the grating. In this apparatus, because the grating is covered with a cover glass, the grating is immune to the heat of vaporization, which makes it possible to measure the position of the wafer stage with high precision.

However, it was difficult to employ the placement of the encoder main body adopted in the exposure apparatus related to the fifth embodiment of U.S. Patent Application Publication No. 2008/0094594, because the stage device is a stage device of a so-called coarse/fine movement structure, which is a combination of a coarse movement stage that moves on a surface plate and a fine movement stage that holds a wafer and relatively moves with respect to the coarse movement stage on the coarse movement stage, and in the case of measuring positional information of the fine movement stage, the coarse movement stage came between the fine movement stage and the surface plate.

Further, while it is desirable to measure positional information of the wafer stage within the two-dimensional plane the same as the exposure point on the wafer surface when exposure to the wafer on the wafer stage is performed, in the case when the wafer stage is inclined with respect to the two-dimensional plane, measurement errors which are caused by a height difference of a wafer surface and a placement surface of the grating would be included, for example, in measurement values of an encoder which measures the position of the wafer stage from below.

### SUMMARY OF THE INVENTION

According to a first aspect of the present invention, there is provided a first exposure apparatus that exposes an object with an energy beam via an optical system supported by a first support member, the apparatus comprising: a movable body that holds the object and is movable along a predetermined plane; a guide surface forming member that forms a guide surface used when the movable body moves along the predetermined plane; a second support member that is placed apart from the guide surface forming member on a side opposite to the optical system, via the guide surface forming member, and whose positional relation with the first support member is maintained at a predetermined state; a position measuring system which includes a first measurement member that irradiates a measurement surface parallel to the predetermined plane with a measurement beam and receives light from the measurement surface, and which obtains positional information of the movable body within the predetermined plane based on an output of the first measurement member, the measurement surface being arranged at one of the movable body and the second support member and at least a part of the first measurement member being arranged at the other of the movable body and the second support member; and a tilt measuring system which obtains tilt information with respect to the predetermined plane of the movable body.

According to this apparatus, the positional information of the movable body within the predetermined plane is obtained by the position measuring system, and the tilt information of the movable body with respect to the predetermined plane is obtained by the tilt measuring system. Accordingly, it becomes possible to drive the movable body with high precision taking into consideration the position error caused by the tilt of the movable body. In this case, the guide surface is used to guide the movable body in a direction orthogonal to the predetermined plane and can be of a contact type or a noncontact type. For example, the guide method of the noncontact type includes a configuration using static gas bearings such as air pads, a configuration using magnetic levitation, and the like. Further, the guide surface is not limited to a configuration in which the movable body is guided following the shape of the guide surface. For example, in the configuration using static gas bearings such as air pads, the opposed surface of the guide surface forming member that is opposed to the movable body is finished so as to have a high flatness degree and the movable body is guided in a noncontact manner via a predetermined gap so as to follow the shape of the opposed surface. On the other hand, in the configuration in which while a part of a motor or the like that uses an electromagnetic force is placed at the guide surface forming member, apart of the motor or the like is placed also at the movable body, and a force acting in a direction orthogonal to the predetermined plane described above is generated by the guide surface forming member and the movable body cooperating, the position of the movable body is controlled by the force on a predetermined plane. For example, a configuration is also included in which a planar motor is arranged at the guide surface forming member and forces in directions which include two directions orthogonal to each other within the predetermined plane and the direction orthogonal to the predetermined plane are made to be generated on the movable body and the movable body is levitated in a noncontact manner without arranging the static gas bearings.

According to a second aspect of the present invention, there is provided a second exposure apparatus that exposes an object with an energy beam via an optical system supported by a first support member, the apparatus comprising: a movable body that holds the object and is movable along a predetermined plane; a second support member whose positional relation with the first support member is maintained in a predetermined state; a movable body supporting member placed between the optical system and the second support member so as to be apart from the second support member, which supports the movable body at least at two points of the movable body in a direction orthogonal to a longitudinal direction of the second support member when the movable body moves along the predetermined plane; a position measuring system which includes a first measurement member that irradiates a measurement surface parallel to the predetermined plane with a measurement beam and receives light from the measurement surface, and which obtains positional information of the movable body within the predetermined plane based on an output of the first measurement member, the measurement surface being arranged at one of the movable body and the second support member and at least a part of the first measurement member being arranged at the other of the movable body and the second support member; and a tilt measuring system which obtains tilt information with respect to the predetermined plane of the movable body.

According to this apparatus, the positional information of the movable body within the predetermined plane is obtained by the position measuring system, and the tilt information of the movable body with respect to the predetermined plane is obtained by the tilt measuring system. Accordingly, it becomes possible to drive the movable body with high precision taking into consideration the position error caused by the tilt of the movable body. In this case, the movable body supporting member supporting the movable body at least in two points in the direction orthogonal to the longitudinal direction of the second support member means that the movable body is supported in the direction orthogonal to the longitudinal direction of the second support member, for example, at only both ends or at both ends and a mid section in the direction orthogonal to the two-dimensional plane, at a section excluding the center and both ends in the direction orthogonal to the longitudinal direction of the second support member, the entire section including both ends in the direction orthogonal to the longitudinal direction of the second support member, or the like. In this case, the method of the support widely includes the contact support, as a matter of course, and the noncontact support such as the support via static gas bearings such as air pads or the magnetic levitation or the like.

According to a third aspect of the present invention, there is provided a device manufacturing method, including exposing an object with the exposure apparatus of the present invention; and developing the exposed object.

According to a fourth aspect of the present invention, there is provided an exposure method in which an object is exposed with an energy beam via an optical system supported by a first support member, the method comprising: irradiating a measurement beam on a measurement plane, which is parallel to the predetermined plane and is provided on one of the movable body and a second support member that is placed apart from a guide surface forming member forming a guide surface when the movable body moves along the predetermined plane on an opposite side of the optical system with the guide surface forming member in between and whose positional relation with the first support member is maintained at a predetermined state, and obtaining positional information of a movable body, which holds the object and is movable along a predetermined plane, at least within the predetermined plane, based on an output of a first measurement member which has at least a part of the member provided on the movable body receiving light from the measurement plane and the other of the second support member, and driving the movable body, based on positional information of the movable body within the predetermined plane and correction information of position errors caused by a tilt of the movable body.

According to this method, the movable body is driven based on the positional information of the movable body in the predetermined plane and the correction information of the position error due to the tilt of the movable body. Accordingly, it becomes possible to drive the movable body with high precision, without being affected by the position error due to the tilt of the movable body.

According to a fifth aspect of the present invention, there is provided a device manufacturing method, including exposing an object by the exposure method of the present invention; and developing the object which has been exposed.

### BRIEF DESCRIPTION OF THE DRAWINGS

In the accompanying drawings;

FIG. 1 is a view schematically showing a configuration of an exposure apparatus of an embodiment;

FIG. 2 is a plan view of the exposure apparatus of FIG. 1;

FIG. 3 is a side view of the exposure apparatus of FIG. 1 when viewed from the +Y side;

FIG. 4A is a plan view of a wafer stage WST1 which the exposure apparatus is equipped with, FIG. 4B is an end view of the cross section taken along the line B-B of FIG. 4A, and FIG. 4C is an end view of the cross section taken along the line C-C of FIG. 4A;

FIG. 5 is a view showing a configuration of a fine movement stage position measuring system;

FIG. 6 shows a schematic configuration of an X head;

FIG. 7 is a block diagram used to explain input/output relations of a main controller which the exposure apparatus of FIG. 1 is equipped with;

FIG. 8 is a graph showing a measurement error of an encoder with respect to a Z position of the fine movement stage in pitching amount θx;

FIGS. 9A and 9B are views showing a case when a measurement arm moves vertically (vertical vibration) in the Z-axis direction (a vertical direction);

FIG. 10 is a figure showing an example of a configuration of a measuring system which measures a variation of the measurement bar;

FIG. 11 is a view showing a state where exposure is performed on a wafer placed on wafer stage WST1, and wafer exchange is performed on wafer stage WST2;

FIG. 12 is a view showing a state where exposure is performed on a wafer mounted on wafer stage WST1 and wafer alignment is performed to a wafer mounted on wafer stage WST2;

FIG. 13 is a view showing a state where wafer stage WST2 moves toward a right-side scrum position on a surface plate 14B;

FIG. 14 is a view showing a state where movement of wafer stage WST1 and wafer stage WST2 to the scrum position is completed;

FIG. 15 is a view showing a state where exposure is performed on a wafer mounted on wafer stage WST2 and wafer exchange is performed on wafer stage WST1;

FIG. 16 is a figure showing a configuration of a measuring system which measures a variation of the measurement bar related to a modified example;

FIG. 17 is a view showing a schematic configuration of a 2D head related to a first modified example;

FIG. 18 is a view showing a schematic configuration of a 2D head related to a second modified example; and

FIG. 19 is a view showing a schematic configuration of a 2D head related to a third modified example.

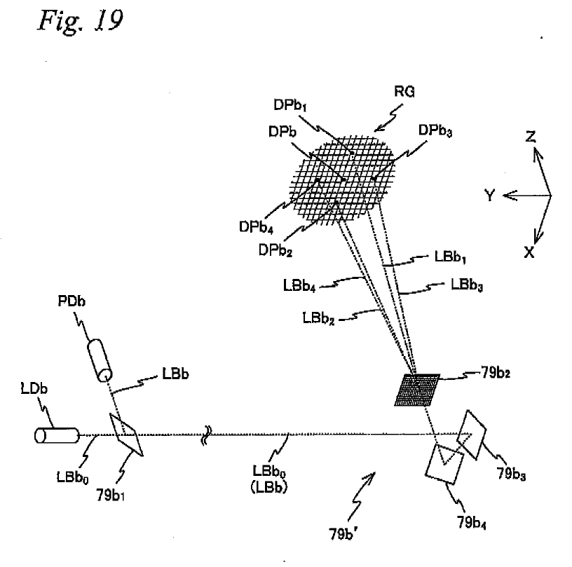

### DESCRIPTION OF THE EMBODIMENTS

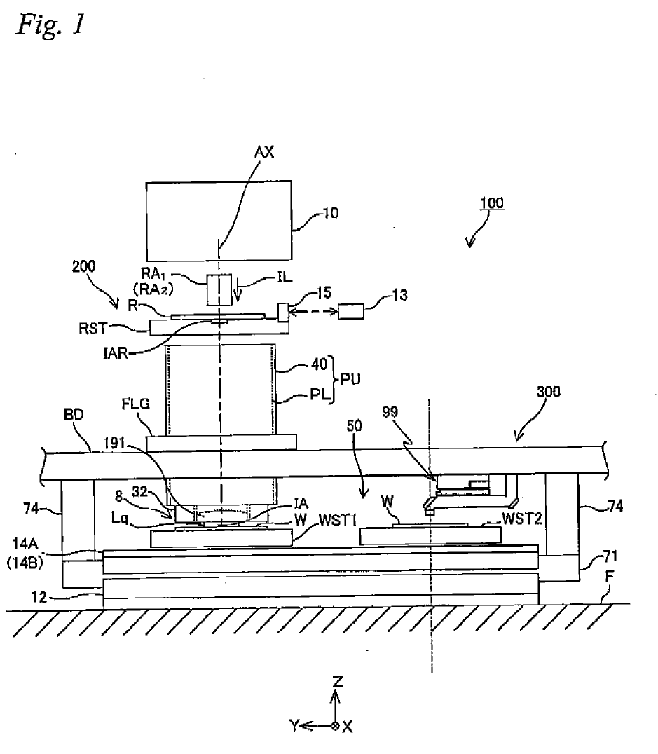

An embodiment of the present invention is described below, with reference to FIGS. 1 to 15.

FIG. 1 schematically shows a configuration of an exposure apparatus 100 related to the embodiment. Exposure apparatus 100 is a projection exposure apparatus by a step-and-scan method, which is a so-called scanner. As described later on, a projection optical system PL is provided in the present embodiment, and in the description below, the explanation is given assuming that a direction parallel to an optical axis ΔX of projection optical system PL is a Z-axis direction, a direction in which a reticle and a wafer are relatively scanned within a plane orthogonal to the Z-axis direction is a Y-axis direction, and a direction orthogonal to the Z-axis and the Y-axis is an X-axis direction, and rotational (tilt) directions around the X-axis, Y-axis and Z-axis are θx, θy and θz directions, respectively.

As shown in FIG. 1, exposure apparatus 100 is equipped with an exposure station (exposure processing section) 200 placed in the vicinity of the +Y side end on a base board 12, a measurement station (measurement processing section) 300 placed in the vicinity of the −Y side end on base board 12, a stage device 50 that includes two wafer stages WST1 and WST2, their control system and the like. In FIG. 1, wafer stage WST1 is located in exposure station 200 and a wafer W is held on wafer stage WST1. And, wafer stage WST2 is located in measurement station 300 and another wafer W is held on wafer stage WST2.

Exposure station 200 is equipped with an illuminations system 10, a reticle stage RST, a projection unit PU, a local liquid immersion device 8, and the like.

Illumination system 10 includes: a light source; and an illumination optical system that has an illuminance uniformity optical system including an optical integrator and the like, and a reticle blind and the like (none of which are illustrated), as disclosed in, for example, U.S. Patent Application Publication No. 2003/0025890 and the like. Illumination system 10 illuminates a slit-shaped illumination area TAR, which is defined by the reticle blind (which is also referred to as a masking system), on reticle R with illumination light (exposure light) IL with substantially uniform illuminance. As illumination light IL, ArF excimer laser light (wavelength: 193 nm) is used as an example.

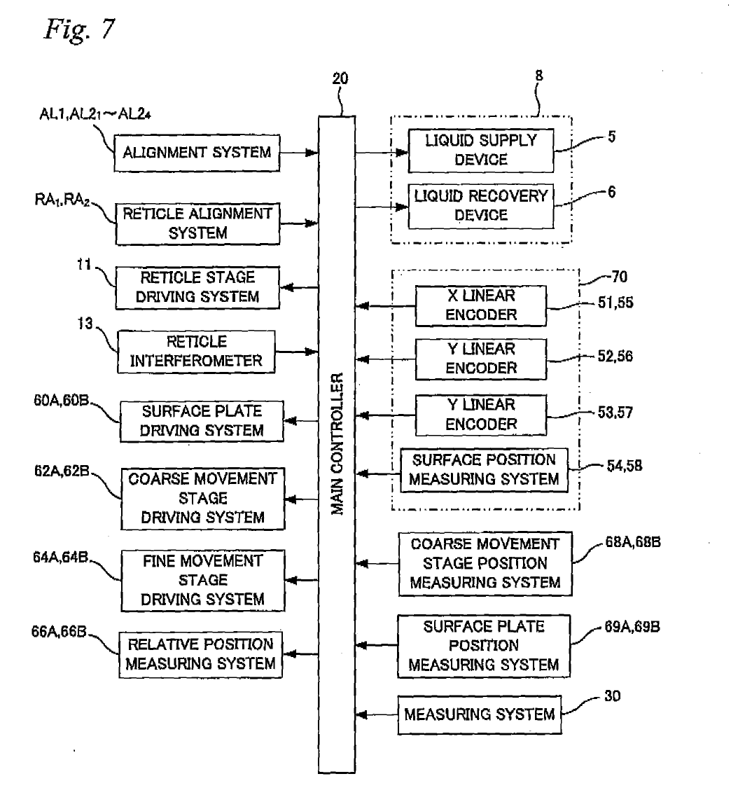

On reticle stage RST, reticle R having a pattern surface (the lower surface in FIG. 1) on which a circuit pattern and the like are formed is fixed by, for example, vacuum adsorption. Reticle stage RST can be driven with a predetermined stroke at a predetermined scanning speed in a scanning direction (which is the Y-axis direction being a lateral direction of the page surface of FIG. 1) and can also be finely driven in the X-axis direction, with a reticle stage driving system 11 (not illustrated in FIG. 1, see FIG. 7) including, for example, a linear motor or the like.

Positional information within the XY plane (including rotational information in the θz direction) of reticle stage RST is constantly detected at a resolution of, for example, around 0.25 nm with a reticle laser interferometer (hereinafter, referred to as a “reticle interferometer”) 13 via a movable mirror 15 fixed to reticle stage RST (actually, a Y movable mirror (or a retroreflector) that has a reflection surface orthogonal to the Y-axis direction and an X movable mirror that has a reflection surface orthogonal to the X-axis direction are arranged). The measurement values of reticle interferometer 13 are sent to a main controller 20 (not illustrated in FIG. 1, see FIG. 7). Incidentally, the positional information of reticle stage RST can be measured by an encoder system as is disclosed in, for example, U.S. Patent Application Publication 2007/0288121 and the like.

Above reticle stage AST, a pair of reticle alignment systems RA₁ and RA₂ by an image processing method, each of which has an imaging device such as a CCD and uses light with an exposure wavelength (illumination light IL in the present embodiment) as alignment illumination light, are placed (in FIG. 1, reticle alignment system RA₂ hides behind reticle alignment system RA₁ in the depth of the page surface), as disclosed in detail in, for example, U.S. Pat. No. 5,646,413 and the like. Main controller 20 (refer to FIG. 7) detects projected images of a pair of reticle alignment marks (drawing omitted) formed on reticle R and a pair of first fiducial marks on a measurement plate, which is described later, on fine movement stage WFS1 (or WFS2), that correspond to the reticle alignment marks via projection optical system PL in a state where the measurement plate is located directly under projection optical system PL, and the pair of reticle alignment systems RA₁ and RA₂ are used to calculate a positional relation between the center of a projection domain of a pattern of reticle R by projection optical system PL and a fiducial position on the measurement plate, namely the center of the pair of the first fiducial marks, according to such detection performed by main controller 20. The detection signals of reticle alignment systems RA₁ and RA₂ are supplied to main controller 20 (see FIG. 7) via a signal processing system that is not illustrated. Incidentally, reticle alignment systems RA₁ and RA₂ do not have to be arranged. In such a case, it is preferable that a detection system that has a light-transmitting section (photodetection section) arranged at a fine movement stage, which is described later on, is installed so as to detect projected images of the reticle alignment marks, as disclosed in, for example, U.S. Patent Application Publication No. 2002/0041377 and the like.

Projection unit PU is placed below reticle stage RST in FIG. 1. Projection unit PO is supported, via a flange section FLG that is fixed to the outer periphery of projection unit PU, by a main frame (which is also referred to as a metrology frame) ED that is horizontally supported by a support member that is not illustrated. Main frame BD can be configured such that vibration from the outside is not transmitted to the main frame or the main frame does not transmit vibration to the outside, by arranging a vibration isolating device or the like at the support member. Projection unit PU includes a barrel 40 and projection optical system PL held within barrel 40. As projection optical system PL, for example, a dioptric system that is composed of a plurality of optical elements (lens elements) that are disposed along optical axis AX parallel to the Z-axis direction is used. Projection optical system PL is, for example, both-side telecentric and has a predetermined projection magnification (e.g. one-quarter, one-fifth, one-eighth times, or the like). Therefore, when illumination area IAR on reticle R is illuminated with illumination light IL from illumination system 10, illumination light IL passes through reticle R whose pattern surface is placed substantially coincident with a first plane (object plane) of projection optical system PL. Then, a reduced image of a circuit pattern (a reduced image of apart of a circuit pattern) of reticle R within illumination area IAR is formed in an area (hereinafter, also referred to as an exposure area) IA that is conjugate to illumination area IAR described above on wafer W which is placed on the second plane (image plane) side of projection optical system PL and whose surface is coated with a resist (sensitive agent), via projection optical system PL (projection unit PU). Then, by moving reticle R relative to illumination area TAR (illumination light IL) in the scanning direction (Y-axis direction) and also moving wafer W relative to exposure area IA (illumination light IL) in the scanning direction (Y-axis direction) by synchronous drive of reticle stage RST and wafer stage WST1 (or WST2), scanning exposure of one shot area (divided area) on wafer W is performed. Accordingly, a pattern of reticle R is transferred onto the shot area. More specifically, in the embodiment, a pattern of reticle R is generated on wafer W by illumination system 10 and projection optical system PL, and the pattern is formed on wafer W by exposure of a sensitive layer (resist layer) on wafer W with illumination light (exposure light) IL. In this case, projection unit PU is held by main frame BD, and in the embodiment, main frame BD is substantially horizontally supported by a plurality (e.g. three or four) of support members placed on an installation surface (such as a floor surface) each via a vibration isolating mechanism. Incidentally, the vibration isolating mechanism can be placed between each of the support members and main frame BD. Further, as disclosed in, for example, PCT International Publication No. 2006/038952, main frame BD (projection unit PU) can be supported in a suspended manner by a main frame member (not illustrated) placed above projection unit PU or a reticle base or the like.

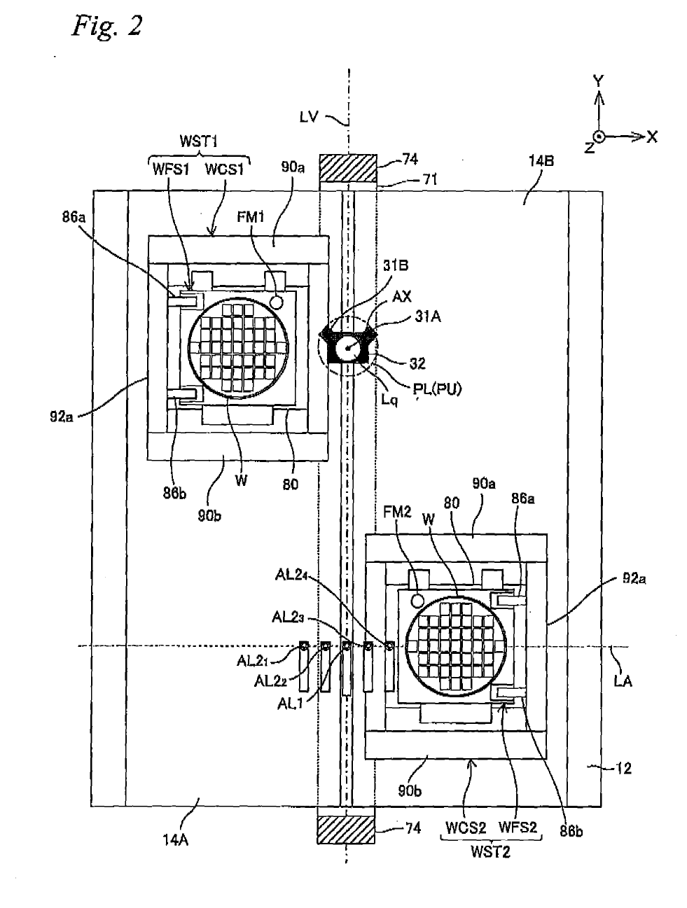

Local liquid immersion device includes a liquid supply device 5, a liquid recovery device 6 (none of which are illustrated in FIG. 1, see FIG. 7), and a nozzle unit 32 and the like. As shown in FIG. 1, nozzle unit 32 is supported in a suspended manner by main frame BD that supports projection unit PU and the like, via a support member that is not illustrated, so as to enclose the periphery of the lower end of barrel 40 that holds an optical element closest to the image plane side (wafer W side) that configures projection optical system PL, which is a lens (hereinafter, also referred to as a “tip lens”) 191 in this Case. Nozzle unit 32 is equipped with a supply opening and a recovery opening of a liquid Lq, a lower surface to which wafer W is placed so as to be opposed and at which the recovery opening is arranged, and a supply flow channel and a recovery flow channel that are respectively connected to a liquid supply pipe 31A and a liquid recovery pipe 31B (none of which are illustrated in FIG. 1, see FIG. 2). One end of a supply pipe (not illustrated) is connected to liquid supply pipe 31A, while the other end of the supply pipe is connected to liquid supply device 5, and one end of a recovery pipe (not illustrated) is connected to liquid recovery pipe 31B, while the other end of the recovery pipe is connected to liquid recovery device 6.

In the present embodiment, main controller 20 controls liquid supply device 5 (see FIG. 7) to supply the liquid to the space between tip lens 191 and wafer W and also controls liquid recovery device 6 (see FIG. 7) to recover the liquid from the space between tip lens 191 and wafer W. On this operation, main controller 20 controls the quantity of the supplied liquid and the quantity of the recovered liquid in order to hold a constant quantity of liquid Lq (see FIG. 1) while constantly replacing the liquid in the space between tip lens 191 and wafer W. In the embodiment, as the liquid described above, a pure water (with a refractive index n 1.44) that transmits the ArF excimer laser light (the light with a wavelength of 193 nm) is to be used.

Measurement station 300 is equipped with an alignment device 99 arranged at main frame BD. Alignment device 99 includes five alignment systems AL1 and AL2₁ to AL2₄ shown in FIG. 2, as disclosed in, for example, U.S. Patent Application Publication No 2008/0088843 and the like. To be more specific, as shown in FIG. 2, a primary alignment system AL1 is placed in a state where its detection center is located at a position a predetermined distance apart on the −Y side from optical axis AX, on a straight line (hereinafter, referred to as a reference axis) LV that passes through the center of projection unit PU (which is optical axis AX of projection optical system PL, and in the present embodiment, which also coincides with the center of exposure area IA described previously) and is parallel to the Y-axis. On one side and the other side in the X-axis direction with primary alignment system AL1 in between, secondary alignment systems AL2₁ and AL2₂, and AL2₃ and AL2₄, whose detection centers are substantially symmetrically placed with respect to reference axis LV, are arranged respectively. More specifically, the detection centers of the five alignment systems AL1 and AL2₁ to AL2₄ are placed along a straight line (hereinafter, referred to as a reference axis) LA that vertically intersects reference axis LV at the detection center of primary alignment system AL1 and is parallel to the X-axis. Incidentally, in FIG. 1, the five alignment systems AL1 and AL2₁ to AL2₄, including a holding device (slider) that holds these alignment systems are shown as alignment device 99. As disclosed in, for example, U.S. Patent Application Publication No. 2009/0233234 and the like, secondary alignment systems AL2₁ to AL2₄ are fixed to the lower surface of main frame BD via the movable slider (see FIG. 1), and the relative positions of the detection areas of the secondary alignment systems are adjustable at least in the X-axis direction with a drive mechanism that is not illustrated.

In the present embodiment, as each of alignment systems AL1 and AL2₁ to AL2₄, for example, an FIA (Field Image Alignment) system by an image processing method is used. The configurations of alignment systems AU and AL2₁ to AL2₄ are disclosed in detail in, for example, PCT International Publication No. 2008/056735 and the like. The imaging signal from each of alignment systems AL1 and AL2₁ to AL2₄ is supplied to main controller 20 (see FIG. 7) via a signal processing system that is not illustrated.

Incidentally, although it is not shown, exposure apparatus 100 has a first loading position where load of the wafer to wafer stage WST1 and unload of the wafer from wafer stage WST1 is performed, and a second loading position where load of the wafer to wafer stage WST2 and unload of the wafer from wafer stage WST1 is performed. In the case of the present embodiment, the first loading position is arranged on the surface plate 14A side and the second loading position is arranged on the surface plate 14B side.

As shown in FIG. 1, stage device 50 is equipped with base board 12, a pair of surface plates 14A and 143 placed above base board 12 (in FIG. 1, surface plate 143 is hidden behind surface plate 14A in the depth of the page surface), two wafer stages WST1 and WST2 that move on a guide surface parallel to the XY plane formed on the upper surface of the pair of surface plates 14A and 14a, and a measurement system that measures positional information of wafer stages WST1 and WST2.

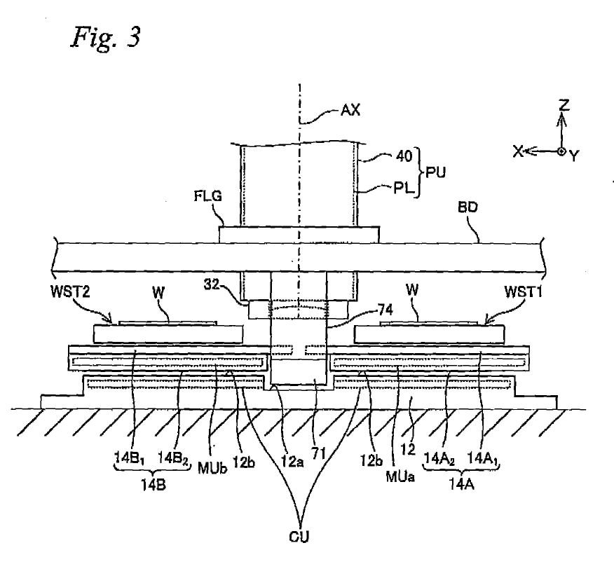

Base board 12 is made up of a member having a tabular outer shape, and as shown in FIG. 1, is substantially horizontally (parallel to the XY plane) supported via a vibration isolating mechanism (drawing omitted) on a floor surface 102. In the center portion in the X-axis direction of the upper surface of base board 12, a recessed section 12a (recessed groove) extending in a direction parallel to the Y-axis is formed, as shown in FIG. 3. On the upper surface side of base board 12 (excluding a portion where recessed section 12a is formed, in this case), a coil unit CU is housed that includes a plurality of coils placed in the shape of a matrix with the XY two-dimensional directions serving as a row direction and a column direction. Incidentally, the vibration isolating mechanism does not necessarily have to be arranged.

As shown in FIG. 2, surface plates 14A and 14B are each made up of a rectangular plate-shaped member whose longitudinal direction is in the Y-axis direction in a planar view (when viewed from above) and are respectively placed on the −X side and the +X side of reference axis LV. Surface plate 14A and surface plate 14B are placed with a very narrow gap therebetween in the X-axis direction, symmetric with respect to reference axis LV. By finishing the upper surface (the +Z side surface) of each of surface plates 14A and 14B such that the upper surface has a very high flatness degree, it is possible to make the upper surfaces function as the guide surface with respect to the Z-axis direction used when each of wafer stages WST1 and WST2 moves following the XY plane. Alternatively, a configuration can be employed in which a force in the Z-axis direction is made to act on wafer stages WST1 and WST2 by planar motors, which are described later on, to magnetically levitate wafer stages WST1 and WST2 above surface plates 14A and 14B. In the case of the present embodiment, the configuration that uses the planar motors is employed and static gas bearings are not used, and therefore, the flatness degree of the upper surfaces of surface plates 14A and 14B does not have to be so high as in the above description.

As shown in FIG. 3, surface plates 14A and 14B are supported on upper surfaces 12b of both side portions of recessed section 12a of base board 12 via air bearings (or rolling bearings) that are not illustrated.

Surface plates 14A and 14B respectively have first sections 14A₁ and 14B₁ each having a relatively thin plate shape on the upper surface of which the guide surface is formed, and second sections 14A₂ and 14B₂ each having a relatively thick plate shape and being short in the X-axis direction that are integrally fixed to the lower surfaces of first sections 14A₁ and 14B₁, respectively. The end on the +X side of first section 14A₁ of surface plate 14A slightly overhangs, to the +X side, the end surface on the +X side of second section 14A₂, and the end on the −X side of first section 14B₁ of surface plate 14B slightly overhangs, to the −X side, the end surface on the −X side of second section 14B₂. However, the configuration is not limited to the above-described one, and a configuration can be employed in which the overhangs are not arranged.

Inside each of first sections 14A₁ and 14B₁, a coil unit (drawing omitted) is housed that includes a plurality of coils placed in a matrix shape with the XY two-dimensional directions serving as a row direction and a column direction. The magnitude and direction of the electric current supplied to each of the plurality of coils that configure each of the coil units are controlled by main controller 20 (see FIG. 7). Inside (on the bottom portion of) second section 14A₂ of surface plate 14A, a magnetic unit MUa, which is made up of a plurality of permanent magnets (and yokes not shown) placed in the shape of a matrix with the XY two-dimensional directions serving as a row direction and a column direction, is housed so as to correspond to coil unit CU housed on the upper surface side of base board 12. Magnetic unit MUa configures, together with coil unit CU of base board 12, a surface plate driving system 60A (see FIG. 7) that is made up of a planar motor by the electromagnetic force (Lorentz force) drive method that is disclosed in, for example, U.S. Patent Application Publication No. 2003/0085676 and the like. Surface plate driving system 60A generates a drive force that drives surface plate 14A in directions of three degrees of freedom (X, Y, θz) within the XY plane.

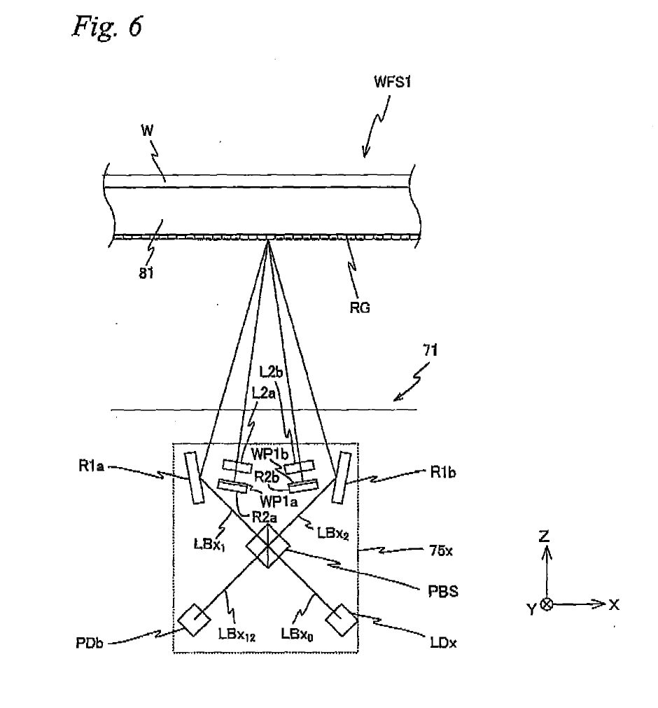

Similarly, inside (on the bottom portion of) second section 14B₂ of surface plate 145, a magnetic unit MUb made up of a plurality of permanent magnets (and yokes not shown) is housed that configures, together with coil unit CU of base board 12, a surface plate driving system 60B (see FIG. 6) made up of a planar motor that drives surface plate 145 in the directions of three degrees of freedom within the XY plane. Incidentally, the placement of the coil unit and the magnetic unit of the planar motor that configures each of surface plate driving systems 60A and 60B can be reverse (a moving coil type that has the magnetic unit on the base board side and the coil unit on the surface plate side) to the above-described case (a moving magnet type).

Positional information of surface plates 14A and 14B in the directions of three degrees of freedom is obtained (measured) independently from each other by a first surface plate position measuring system 69A and a second surface plate position measuring system 695 (see FIG. 7), respectively, which each include, for example, an encoder system. The output of each of first surface plate position measuring system 69A and second surface plate position measuring system 69B is supplied to main controller 20 (see FIG. 7), and main controller 20 controls the magnitude and direction of the electric current supplied to the respective coils that configure the coil units of surface plate driving systems 60A and 60B, based on the outputs of surface plate position measuring systems 69A and 69B, thereby controlling the respective positions of surface plates 14A and 14B in the directions of three degrees of freedom within the XY plane, as needed. Main controller 20 drives surface plates 14A and 14B via surface plate driving systems 60A and 60B based on the outputs of surface plate position measuring systems 69A and 69B to return surface plates 14A and 14B to the reference position of the surface plates such that the movement distance of surface plates 14A and 14B from the reference position falls within a predetermined range, when surface plates 14A and 14B function as the countermasses to be described later on. More specifically, surface plate driving systems 60A and 60B are used as trim motors.

While the configurations of first surface plate position measuring system 69A and second surface plate position measuring system 69B are not especially limited, an encoder system can be used in which, for example, encoder head sections, which obtain (measure) positional information of the respective surface plates 14A and 14B in the directions of three degrees of freedom within the XY plane by irradiating measurement beams on scales (e.g. two-dimensional gratings) placed on the lower surfaces of second sections 14A₂ and 14B₂ respectively and receiving diffraction light (reflected light) generated by the two-dimensional grating, are placed at base board 12 (or the encoder head sections are placed at second sections 14A₂ and 14B₂ and scales are placed at base board 12, respectively). Incidentally, it is also possible to obtain (measure) the positional information of surface plates 14A and 14B by, for example, an optical interferometer system or a measuring system that is a combination of an optical interferometer system and an encoder system.

One of the wafer stages, wafer stage WST1 is equipped with a fine movement stage WFS1 that holds wafer W and a coarse movement stage WCS1 having a rectangular frame shape that encloses the periphery of fine movement stage WFS1, as shown in FIG. 2. The other of the wafer stages, wafer stage WST2 is equipped with a fine movement stage WFS2 that holds wafer W and a coarse movement stage WCS2 having a rectangular frame shape that encloses the periphery of fine movement stage WFS2, as shown in FIG. 2. As is obvious from FIG. 2, wafer stage WST2 has completely the same configuration including the driving system, the position measuring system and the like, as wafer stage WST1 except that wafer stage WST2 is placed in a state laterally reversed with respect to wafer stage WST1. Consequently, in the description below, wafer stage WST1 is representatively focused on and described, and wafer stage WST2 is described only in the case where such description is especially needed.

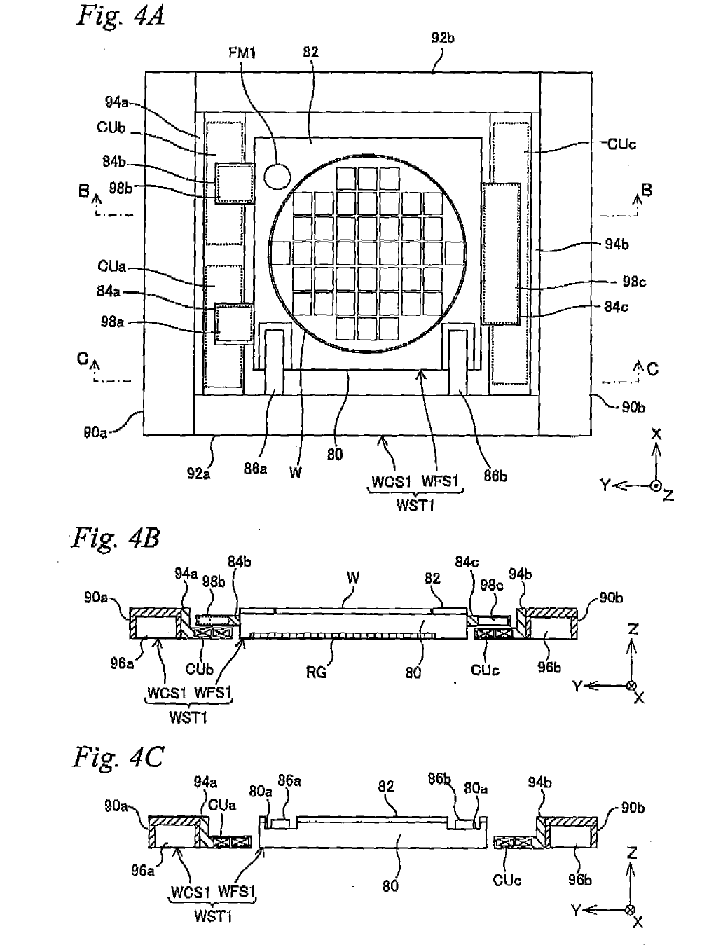

As shown in FIG. 4A, coarse movement stage WCS1 has a pair of coarse movement slider sections 90a and 90b which are placed parallel to each other, spaced apart in the Y-axis direction, and each of which is made up of a rectangular parallelepiped member whose longitudinal direction is in the X-axis direction, and a pair of coupling members 92a and 92b each of which is made up of a rectangular parallelepiped member whose longitudinal direction is in the Y-axis direction, and which couple the pair of coarse movement slider sections 90a and 90b with one ends and the other ends thereof in the Y-axis direction. More specifically, coarse movement stage WCS1 is formed into a rectangular frame shape with a rectangular opening section, in its center portion, that penetrates in the Z-axis direction.

Inside (on the bottom portions of) coarse movement slider sections 90a and 90b, as shown in FIGS. 4B and 4C, magnetic units 96a and 96b are housed respectively. Magnetic units 96a and 96b correspond to the coil units housed inside first sections 14A₁ and 14B₁ of surface plates 19A and 14B, respectively, and are each made of up a plurality of magnets placed in the shape of a matrix with the XY two-dimensional directions serving as a row direction and a column direction. Magnetic units 96a and 96b configure, together with the coil units of surface plates 14A and 14B, a coarse movement stage driving system 62A (see FIG. 7) that is made up of a planar motor by an electromagnetic force (Lorentz force) drive method that is capable of generating drive forces in the X-axis direction, the Y-axis direction, the Z-axis direction, the θx direction, the θy direction, and the θz direction (hereinafter described as directions of six degrees of freedom, or directions (X, Y, Z, θx, θy, and θz) of six degrees of freedom) to coarse movement stage WCS1, which is disclosed in, for example, U.S. Patent Application Publication No. 2003/0085676 and the like. Further, similar thereto, magnetic units, which coarse movement stage WCS2 (see FIG. 2) of wafer stage WST2 has, and the coil units of surface plates 14A and 14B configure a coarse movement stage driving system 62B (see FIG. 7) made up of a planar motor. In this case, since a force in the Z-axis direction acts on coarse movement stage WCS1 (or WCS2), the coarse movement stage is magnetically levitated above surface plates 14A and 14B. Therefore, it is not necessary to use static gas bearings for which relatively high machining accuracy is required, and thus it becomes unnecessary to increase the flatness degree of the upper surfaces of surface plates 14A and 14B.

Incidentally, while coarse movement stages WCS1 and WCS2 of the present embodiment have the configuration in which only coarse movement slider sections 90a and 90b have the magnetic units of the planar motors, the present embodiment is, not limited to this, and the magnetic unit can be placed also at coupling members 92a and 92b. Further, the actuators to drive coarse movement stages WCS1 and WCS2 are not limited to the planar motors by the electromagnetic force (Lorentz force) drive method, but for example, planar motors by a variable magnetoresistance drive method or the like can be used. Further, the drive directions of coarse movement stages WCS1 and WCS2 are not limited to the directions of six degrees of freedom, but can be, for example, only directions of three degrees of freedom (X, Y, θz) within the XY plane. In this case, coarse movement stages WCS1 and WCS2 should be levitated above surface plates 14A and 14B, for example, using static gas bearings (e.g. air bearings). Further, in the present embodiment, while the planar motor of a moving magnet type is used as each of coarse movement stage driving systems 62A and 62B, besides this, a planar motor of a moving coil type in which the magnetic unit is placed at the surface plate and the coil unit is placed at the coarse movement stage can also be used.

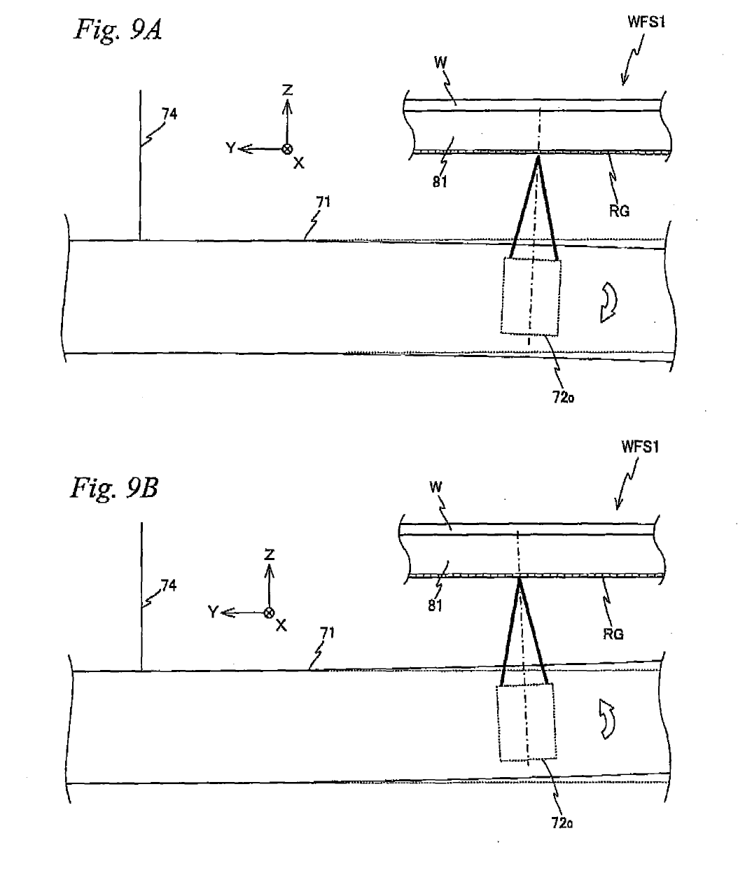

On the side surface on the −Y side of coarse movement slider section 90a and on the side surface +Y the side of coarse movement slider section 90b, guide members 94a and 94b that function as a guide used when fine movement stage WFS1 is finely driven are respectively fixed. As shown in FIG. 9B, guide member 94a is made up of a member having an L-like sectional shape arranged extending in the X-axis direction and its lower surface is placed flush with the lower surface of coarse movement slider 90a. Guide member 94b is configured and placed similar to guide member 94a, although guide member 94b is bilaterally symmetric to guide member 94a.

Inside (on the bottom surface of) guide member 94a, a pair of coil units CUa and CUb, each of which includes a plurality of coils placed in the shape of a matrix with the XY two-dimensional directions serving as a row direction and a column direction, are housed at a predetermined distance in the X-axis direction (see FIG. 4A). Meanwhile, inside (on the bottom portion of) guide member 94b, one coil unit CUc, which includes a plurality of coils placed in the shape of a matrix with the XY two-dimensional directions serving as a row direction and a column direction, is housed (see FIG. 4A). The magnitude and direction of the electric current supplied to each of the coils that configure coil units CUa to CUc are Controlled by main controller 20 (see FIG. 7).

Inside coupling members 92a and/or 92b, various types of optical members (e.g. an aerial image measuring instrument, an uneven illuminance measuring instrument, an illuminance monitor, a wavefront aberration measuring instrument, and the like) can be housed.

In this case, when wafer stage WST1 is driven with acceleration/deceleration in the Y-axis direction on surface plate 14A, by the planar motor that configures coarse movement stage driving system 62A (e.g. when wafer stage WST1 moves between exposure station 200 and measurement station 300), surface plate 14A moves in a direction opposite to wafer stage WST1, according to the so-called law of action and reaction (the law of conservation of momentum) due to the action of a reaction force of the drive of wafer stage WST1. Further, it is also possible to make a state where the law of action and reaction described above does not hold, by generating a drive force in the Y-axis direction with surface plate driving system 60A.

Further, when wafer stage WST2 is driven in the Y-axis direction on surface plate 14B, surface plate 14B is also driven in a direction opposite to wafer stage WST2 according to the so-called law of action and reaction (the law of conservation of momentum) due to the action of a reaction force of a drive force of wafer stage WST2. More specifically, surface plates 14A and 14B function as the countermasses and the momentum of a system composed of wafer stages WST1 and WST2 and surface plates 14A and 14B as a whole is conserved and movement of the center of gravity does not occur. Consequently, any inconveniences do not arise such as the uneven loading acting on surface plates 14A and 14B owing to the movement of wafer stages WST1 and WST2 in the Y-axis direction. Incidentally, regarding wafer stage WST2 as well, it is possible to make a state where the law of action and reaction described above does not hold, by generating a drive force in the Y-axis direction with surface plate driving system 60B.

Further, on movement in the X-axis direction of wafer stages WST1 and WST2, surface plates 14A, and 14B function as the countermasses owing to the action of a reaction force of the drive force.

As shown in FIGS. 4A and 4B, fine movement stage WFS1 is equipped with a main section 80 made up of a member having a rectangular shape in a planar view, a pair of fine movement slider sections 84a and 84b fixed to the side surface on the +Y side of main section 80, and a fine movement slider section 84c fixed to the side surface on the −Y side of main section 80.

Main section 80 is formed by a material with a relatively small coefficient of thermal expansion, e.g., ceramics, glass or the like, and is supported by coarse movement stage WCS1 in a noncontact manner in a state where the bottom surface of the main section is located flush with the bottom surface of coarse movement stage WCS1. Main section 80 can be hollowed for reduction in weight. Incidentally, the bottom surface of main section 80 does not necessarily have to be flush with the bottom surface of coarse movement stage WCS1.

In the center of the upper surface of main section 80, a wafer holder (not shown) that holds wafer W by vacuum adsorption or the like is placed. In the embodiment, the wafer holder by a so-called pin chuck method is used in which a plurality of support sections (pin members) that support wafer W are formed, for example, within an annular protruding section (rim section), and the wafer holder, whose one surface (front surface) serves as a wafer mounting surface, has a two-dimensional grating RG to be described later and the like arranged on the other surface (back surface) side. Incidentally, the wafer holder can be formed integrally with fine movement stage WFS1 (main section 80), or can be fixed to main section 80 so as to be detachable via, for example, a holding mechanism such as an electrostatic chuck mechanism or a clamp mechanism. In this case, grating RG is to be arranged on the back surface side of main section 80. Further, the wafer holder can be fixed to main section 80 by an adhesive agent or the like. On the upper surface of main section 80, as shown in FIG. 4A, a plate (liquid-repellent plate) 82, in the center of which a circular opening that is slightly larger than wafer W (wafer holder) is formed and which has a rectangular outer shape (contour) that corresponds to main section 80, is attached on the outer side of the wafer holder (mounting area of wafer W). The liquid-repellent treatment against liquid Lq is applied to the surface of plate 82 (the liquid-repellent surface is formed). In the embodiment, the surface of plate 82 includes a base material made up of metal, ceramics, glass or the like, and a film of liquid-repellent material formed on the surface of the base material. The liquid-repellent material includes, for example, PFA (Tetra fluoro ethylene-perfluoro alkylvinyl ether copolymer), PTFE (Poly tetra fluoro ethylene), and the like. Incidentally, the material that forms the film can be an acrylic-type resin or a silicon-series resin. Further, the entire plate 82 can be formed with at least one of the PFA, PTFE, Teflon (registered trademark), acrylic-type resin and silicon-series resin. In the present embodiment, the contact angle of the upper surface of plate 82 with respect to liquid Lq is, for example, more than or equal to 90 degrees. On the surface of coupling member 92b described previously as well, the similar liquid-repellent treatment is applied.

Plate 82 is fixed to the upper surface of main section 80 such that the entire surface (or a part of the surface) of plate 82 is flush with the surface of wafer W. Further, the surfaces of plate 82 and wafer W are located substantially flush with the surface of coupling member 92b described previously. Further, in the vicinity of a corner on the +X side located on the +Y side of plate 82, a circular opening is formed, and a measurement plate FM1 is placed in the opening without any gap therebetween in a state substantially flush with the surface of wafer W. On the upper surface of measurement plate FM1, the pair of first fiducial marks to be respectively detected by the pair of reticle alignment systems RA₁ and RA₂ (see FIGS. 1 and 7) described earlier and a second fiducial mark to be detected by primary alignment system AL1 (none of the marks are shown) are formed. In fine movement stage WFS2 of wafer stage WST2, as shown in FIG. 2, in the vicinity of a corner on the −X side located on the +Y side of plate 82, a measurement plate FM2 that is similar to measurement plate FM1 is fixed in a state substantially flush with the surface of wafer W. Incidentally, instead of attaching plate 82 to fine movement stage WFS1 (main section 80), it is also possible, for example, that the wafer holder is formed integrally with fine movement stage WFS1 and the liquid-repellent treatment is applied to the peripheral area, which encloses the wafer holder (the same area as plate 82 (which may include the surface of the measurement plate)), of the upper surface of fine movement stage WFS1 and the liquid repellent surface is formed.

In the center portion of the lower surface of main section 80 of fine movement stage WFS1, as shown in FIG. 4B, a plate having a predetermined thin plate shape, which is large to the extent of covering the wafer holder (mounting area of wafer W) and measurement plate FM1 (or measurement plate FM2 in the case of fine movement stage WFS2), is placed in a state where its lower surface is located substantially flush with the other section (the peripheral section) (the lower surface of the plate does not protrude below the peripheral section). On one surface (the upper surface (or the lower surface)) of the plate, two-dimensional grating RG (hereinafter, simply referred to as grating RG) is formed. Grating RG includes a reflective diffraction grating (X diffraction grating) whose periodic direction is in the X-axis direction and a reflective diffraction grating (Y diffraction grating) whose periodic direction is in the Y-axis direction. The plate is formed by, for example, glass, and grating RG is created by graving the graduations of the diffraction gratings at a pitch, for example, between 138 nm to 4 m, e.g. at a pitch of 1 m. Incidentally, grating RG can also cover the entire lower surface of main section 80. Further, the type of the diffraction grating used for grating RG is not limited to the one on which grooves or the like are formed, but for example, a diffraction grating that is created by exposing interference fringes on a photosensitive resin can also be employed. Incidentally, the configuration of the plate having a thin plate shape is not necessarily limited to the above-described one.

As shown in FIG. 4A, the pair of fine movement slider sections 84a and 84b are each a plate-shaped member having a roughly square shape in a planar view, and are placed apart at a predetermined distance in the X-axis direction, on the side surface on the +Y side of main section 80. Fine movement slider section 84c is a plate-shaped member having a rectangular shape elongated in the X-axis direction in a planar view, and is fixed to the side surface on the −Y side of main section 80 in a state where one end and the other end in its longitudinal direction are located on straight lines parallel to the Y-axis that are substantially collinear with the centers of fine movement slider sections 84a and 84b.

The pair of fine movement slider sections 84a and 84b are respectively supported by guide member 94a described earlier, and fine movement slider section 84c is supported by guide member 94b. More specifically, fine movement stage WFS is supported at three noncollinear positions with respect to coarse movement stage WCS.

Inside fine movement slider sections 84a to 84c, magnetic units 98a, 98b and 98c, which are each made up of a plurality of permanent magnets (and yokes that are not illustrated) placed in the shape of a matrix with the XY two-dimensional directions serving as a row direction and a column direction, are housed, respectively, so as to correspond to coil units CUa to CUc that guide sections 94a and 94b of coarse movement stage WCS1 have. Magnetic unit 98a together with coil unit CUa, magnetic unit 98b together with coil unit Cub, and magnetic unit 98c together with coil unit CUc respectively configure three planar motors by the electromagnetic force (Lorentz force) drive method that are capable of generating drive forces in the X-axis, Y-axis and Z-axis directions, as disclosed in, for example, U.S. Patent Application Publication No 2003/0085676 and the like, and these three planar motors configure a fine movement stage driving system 64A (see FIG. 7) that drives fine movement stage WFS1 in directions of six degrees of freedom (X, Y, Z, θx, θy and θz).

In wafer stage WST2 as well, three planar motors composed of coil units that coarse movement stage WCS2 has and magnetic units that fine movement stage WFS2 has are configured likewise, and these three planar motors configure a fine movement stage driving system 64B (see FIG. 7) that drives fine movement stage WFS2 in directions of six degrees of freedom (X, Y, Z, θx, θy and θz).

Fine movement stage WFS1 is movable in the X-axis direction, with a longer stroke compared with the directions of the other five degrees of freedom, along guide members 94a and 94b arranged extending in the X-axis direction. The same applies to fine movement stage WFS2.

With the configuration as described above, fine movement stage WFS1 is movable in the directions of six degrees of freedom with respect to coarse movement stage WCS1. Further, on this operation, the law of action and reaction (the law of conservation of momentum) that is similar to the previously described one holds owing to the action of a reaction force by drive of fine movement stage WFS1. More specifically, coarse movement stage WCS1 functions as the countermass of fine movement stage WFS1, and coarse movement stage WCS1 is driven in a direction opposite to fine movement stage WFS1. Fine movement stage WFS2 and coarse movement stage WCS2 has the similar relation.

Further, as described earlier, since fine movement stage WFS1 is supported at the three noncollinear positions by coarse movement stage WCS1, main controller 20 can tilt fine movement stage WFS1 (i.e. wafer W) at an arbitrary angle (rotational amount) in the θx direction and/or the θy direction with respect to the XY plane by, for example, appropriately controlling a drive force (thrust) in the Z-axis direction that is made to act on each of fine movement slider sections 84a to 84c. Further, main controller 20 can make the center portion of fine movement stage WFS1 bend in the +Z direction (into a convex shape), for example, by making a drive force in the +θx direction (a counterclockwise direction on the page surface of FIG. 4B) on each of fine movement slider sections 84a and 84b and also making a drive force in the −θx direction (a clockwise direction on the page surface of FIG. 4B) on fine movement slider section 84c. Further, main controller 20 can also make the center portion of fine movement stage WFS1 bend in the +Z direction (into a convex shape), for example, by making drive forces in the −θy direction and the +θy direction (a counterclockwise direction and a clockwise direction when viewed from the +Y side, respectively) on fine movement slider sections 84a and 84b, respectively. Main controller 20 can also perform the similar operations with respect to fine movement stage WFS2.

Incidentally, in the embodiment, as fine movement stage driving systems 64A and 64B, the planar motors of a moving magnet type are used, but the embodiment is not limited to this, and planar motors of a moving coil type in which the coil units are placed at the fine movement slider sections of the fine movement stages and the magnetic units are placed at the guide members of the coarse movement stages can also be used.

Between coupling member 92a of coarse movement stage WCS1 and main section 80 of fine movement stage WFS1, as shown in FIG. 4A, a pair of tubes 86a and 86b used to transmit the power usage, which is supplied from the outside to coupling member 92a via a tube carrier, to fine movement stage WFS1 are installed. One ends of tubes 86a and 86b are connected to the side surface on the +X side of coupling member 92a and the other ends are connected to the inside of main section 80, respectively via a pair of recessed sections 80a (see FIG. 4C) with a predetermined depth each of which is formed from the end surface on the −X side toward the +X direction with a predetermined length, on the upper surface of main section 80. As shown in FIG. 4C, tubes 86a and 86b are configured not to protrude above the upper surface of fine movement stage WFS1. Between coupling member 92a of coarse movement stage WCS2 and main section 80 of fine movement stage WFS2 as well, as shown in FIG. 2, a pair of tubes 86a and 86b used to transmit the power usage, which is supplied from the outside to coupling member 92a, to fine movement stage WFS2 are installed.

Power usage, here, is a generic term of power for various sensors and actuators such as motors, coolant for temperature adjustment to the actuators, pressurized air for air bearings and the like which is supplied from the outside to coupling member 92a via the tube carrier (not shown). In the case where a vacuum suction force is necessary, the force for vacuum (negative pressure) is also included in the power usage.

The tube carrier is arranged in a pair corresponding to wafer stages WST1 and WST2, respectively, and is actually placed each on a step portion formed at the end on the −X side and the +X side of base board 12 shown in FIG. 3, and is driven in the Y-axis direction following wafer stages WST1 and WST2 by actuators such as linear motors on the step portion.

Next, a measuring system that measures positional information of wafer stages WST1 and WST2 is described. Exposure apparatus 100 has a fine movement stage position measuring system 70 (see FIG. 7) to measure positional information of fine movement stages WFS1 and WFS2 and coarse movement stage position measuring systems 68A and 68B (see FIG. 7) to measure positional information of coarse movement stages WCS1 and WCS2 respectively.

Fine movement stage position measuring system 70 has a measurement bar 71 shown in FIG. 1. Measurement bar 71 is placed below first sections 14A₁ and 14B₁ that the pair of surface plates 14A and 14B respectively have, as shown in FIG. 3. As is obvious from FIGS. 1 and 3, measurement bar 71 is made up of a beam-like member having a rectangular sectional shape with the Y-axis direction serving as its longitudinal direction, and both ends in the longitudinal direction are each fixed to main frame BD in a suspended state via a suspended member 74. More specifically, main frame BD and measurement bar 71 are integrated.

The +Z side half (upper half) of measurement bar 71 is placed between second section 14A₂ of surface plate 14A and second section 14B₂ of surface plate 14B, and the −Z side half (lower half) is housed inside recessed section 12a formed at base board 12. Further, a predetermined clearance is formed between measurement bar 71 and each of surface plates 14A and 14B and base board 12, and measurement bar 71 is in a state noncontact with the members other than main frame BD. Measurement bar 71 is formed by a material with a relatively low coefficient of thermal expansion (e.g. invar, ceramics, or the like). Incidentally, the shape of measurement bar 71 is not limited in particular. For example, it is also possible that the measurement member has a circular cross section (a cylindrical shape), or a trapezoidal or triangle cross section. Further, the measurement bar does not necessarily have to be formed by a longitudinal member such as a bar-like member or a beam-like member.

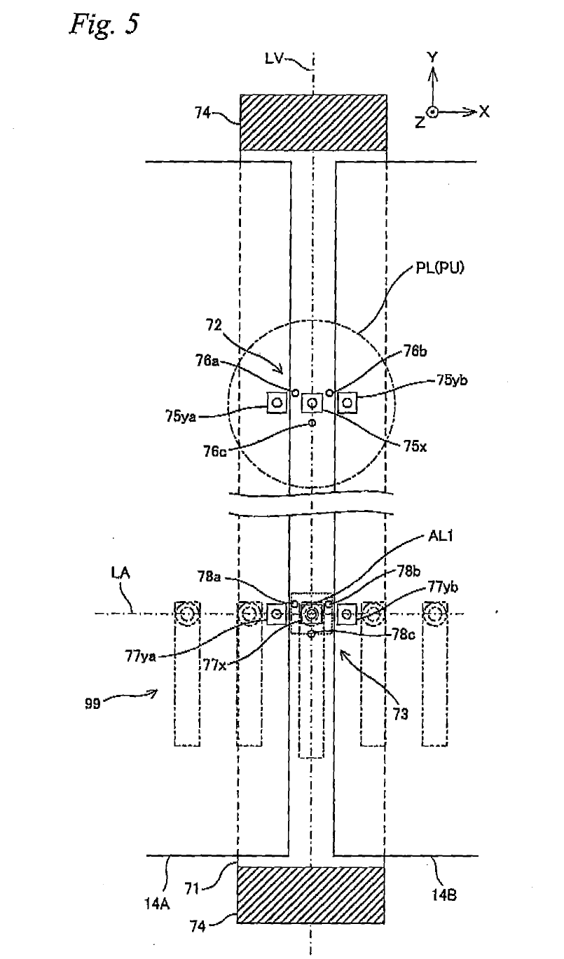

At measurement bar 71, as shown in FIG. 5, a first measurement head group 72 used when measuring positional information of the fine movement stage (WFS1 or WFS2) located below projection unit PU and a second measurement head group 73 used when measuring positional information of the fine movement stage (WFS1 or WFS2) located below alignment device 99 are arranged. Incidentally, alignment systems AL1 and AL2₁ to AL2₄ are shown in virtual lines (two-dot chain lines) in FIG. 5 in order to make the drawing easy to understand. Further, in FIG. 5, the reference signs of alignment systems AL2₁ to AL2₄ are omitted.

As shown in FIG. 5, first measurement head group 72 is placed below projection unit PU and includes a one-dimensional encoder head for X-axis direction measurement (hereinafter, shortly referred to as an X head or an encoder head) 75x, a pair of one-dimensional encoder heads for Y-axis direction measurement (hereinafter, shortly referred to as Y heads or encoder heads) 75ya and 75yb, and three Z heads 76a, 76b and 76c.

X head 75x, Y heads 75ya and 75yb and the three Z heads 76a to 76c are placed in a state where their positions do not vary, inside measurement bar 71. X head 75x is placed on reference axis LV, and Y heads 75ya and 75yb are placed at the same distance away from X head 75x, on the −X side and the +X side, respectively. In the embodiment, as each of the three encoder heads 75x, 75ya and 75yb, a diffraction interference type head is used which is a head in which a light source, a photodetection system (including a photodetector) and various types of optical systems are unitized, similar to the encoder head disclosed in, for example, PCT International Publication No. 2007/083758 (the corresponding U.S. Patent Application Publication No. 2007/0288121) and the like.

A configuration of the three heads 75x, 75ya, and 75yb will now be described. FIG. 6A representatively shows a rough configuration of X head 75x, which represents the three heads 75x, 75ya, and 75yb.

As shown in FIG. 6, X head 75x is equipped with a polarization beam splitter PBS whose separation plane is parallel to the YZ plane, a pair of reflection mirrors R1a and R1b, lenses L2a and L2b, quarter wavelength plates (hereinafter, described as λ/4 plates) WP1a and WP1b, refection mirrors R2a and R2b, light source LDx, photodetection system PDx and the like, and these optical elements are placed in a predetermined positional relation. As shown in FIGS. 5 and 6, X head 75x is untized and fixed to the inside of measurement bar 71.

As shown in FIG. 6, laser beam LBx₀ is emitted from light source LDx, and is incident on polarization beam splitter PBS. Laser beam LBx₀ is split by polarization by polarization beam splitter PBS into two measurement beams LBx₁ and LBx_{z}. Measurement beam LBx₁ having been transmitted through polarization beam splitter PBS reaches grating RG formed on fine movement stage WFS1 (WFS2), via reflection mirror R1a, and measurement beam LBx₂ reflected off polarization beam splitter PBS reaches grating RG via reflection mirror R1b. “Split by polarization,” in this case means the splitting of an incident beam into a P-polarization component and an S-polarization component.

Incidentally, in the case of X head 75x, the two measurement beams LBx₁ and LBx₂ reach grating RG placed on the lower surface of fine movement stage WFS1 for WFS2) via an air gap (refer to FIG. 5) between surface plate 14A and surface plate 14B. Further, in the case of Y heads 75ya and 75yb which will be described later on, the measurement beams reach grating RG via light transmitting sections (e.g. openings) formed in the respective first sections 14A₁ and 14B₁ of surface plates 14A and 14B.

Predetermined-order diffraction beams that are generated from grating RG due to irradiation of measurement beams LBx₁ and LBx₂, such as, for example, the first-order diffraction beams are severally converted into a circular polarized light by λ/4 plates WP1a and WP1b via lenses L2a and L2b, and reflected by reflection mirrors R2a and R2b and then the beams pass through λ/4 plates WP1a and WP1b again and reach polarization beam splitter PBS by tracing the same optical path in the reversed direction.

Each of the polarization directions of the two first-order diffraction beams that have reached polarization beam splitter PBS is rotated at an angle of 90 degrees with respect to the original direction. Therefore, the first-order diffraction beam of measurement beam LBx₁ having passed through polarization beam splitter PBS first, is reflected off polarization beam splitter PBS. The first-order diffraction beam of measurement beam LBx₂ having been reflected off polarization beam splitter PBS first, passes through polarization beam splitter PBS. Accordingly, the first-order diffraction beams of each of the measurement beams LBxᵢ and LBx₂ are coaxially synthesized as a synthetic beam LBx₁₂. Synthetic beam LBx₁₂ is sent to photodetection system PDx.

In photodetection system PDx, the polarization direction of the first-order diffraction beams of beams LBx₁ and LBx₂ synthesized as synthetic beam LBx₁₂ is arranged by a polarizer (analyzer) (not shown) and the beams overlay each other so as to form an interference light, which is detected by the photodetector and is converted into an electric signal in accordance with the intensity of the interference light. When fine movement stage WFS1 moves in the measurement direction (in this case, the X-axis direction) here, a phase difference between the two beams changes, which changes the intensity of the interference light. X head 75x outputs this change in the intensity of the interference light is output as positional information in the X-axis direction of fine movement stage WFS1.

Y heads 75ya and 75yb are unitized as in X head 75x, and are fixed to the inside of measurement bar 71. From Y heads 75ya and 75yb, positional information in the Y axis direction of fine movement stage WFS1 is output.

More specifically, an X liner encoder 51 (see FIG. 7) is configured of X head 75x that outputs the position of fine movement stage WFS1 (or WFS2) in the X-axis direction. And, a pair of Y liner encoders 52 and 53 (see FIG. 7) are configured of the pair of Y heads 75ya and 75yb that measure the position of fine movement stage WFS1 (or WFS2) in the Y-axis direction.

The output (positional information) of X head 75x (X linear encoder 51) and Y heads 75ya and 75yb (Y linear encoders 52 and 53) are supplied to main controller 20 (refer to FIG. 7). Main controller 20 obtains the position in the X-axis direction of fine movement stage WFS1 (or WFS2) from the output (positional information) of X head 75x, and the position in the Y-axis direction and the position (a θz rotation) in the θz direction of fine movement stage WFS1 (or WFS2) from the output (positional information) of the average and the difference of Y heads 75ya and 75yb, respectively.

In this case, an irradiation point (detection point), on grating RG, of the measurement beam irradiated from X head 75x coincides with the exposure position that is the center of exposure area IA (see FIG. 1) on wafer W. Further, a midpoint of a pair of irradiation points (detection points), on grating RG, of the measurement beams respectively irradiated from the pair of Y heads 75ya and 75yb coincides with the irradiation point (detection point), on grating RG, of the measurement beam irradiated from X head 75x. Main controller 20 computes positional information of fine movement stage WFS1 (or WFS2) in the Y-axis direction based on the average of the measurement values of the two Y heads 75ya and 75yb. Therefore, the positional information of fine movement stage WFS1 (or WFS2) in the Y-axis direction is substantially measured at the exposure position that is the center of irradiation area (exposure area) IA of illumination light IL irradiated on wafer W. More specifically, the measurement center of X head 75x and the substantial measurement center of the two Y heads 75ya and 75yb coincide with the exposure position. Consequently, by using X linear encoder 51 and Y linear encoders 52 and 53, main controller 20 can perform measurement of the positional information within the XY plane (including the rotational information in the z direction) of fine movement stage WFS1 (or WFS2) directly under (on the back side of) the exposure position at all times.

As each of Z heads 76a to 76c, for example, a head of a displacement sensor by an optical method similar to an optical pickup used in a CD drive device or the like is used. The three Z heads 76a to 76c are placed at the positions corresponding to the respective vertices of an isosceles triangle (or an equilateral triangle). Z heads 76a to 76e each irradiate the lower surface of fine movement stage WFS1 (or WFS2) with a measurement beam parallel to the Z-axis from below, and receive reflected light reflected by the surface of the plate on which grating RG is formed (or the formation surface of the reflective diffraction grating). Accordingly, Z heads 76a to 76c configure a surface position measuring system 54 (see FIG. 7) that measures the surface position (position in the Z-axis direction) of fine movement stage WFS1 (or WFS2) at the respective irradiation points. The measurement value of each of the three Z heads 76a to 76c is supplied to main controller 20 (see FIG. 7).

The center of gravity of the isosceles triangle (or the equilateral triangle) whose vertices are at the three irradiation points on grating RG of the measurement beams respectively irradiated from the three Z heads 76a to 76c coincides with the exposure position that is the center of exposure area IA (see FIG. 1.) on wafer W. Consequently, based on the average value of the measurement values of the three Z heads 76a to 76c, main controller 20 can acquire positional information in the Z-axis direction (surface position information) of fine movement stage WFS1 (or WFS2) directly under the exposure position at all times. Further, main controller 20 measures (computes) the rotational amount in the x direction and the y direction, in addition to the position in the Z-axis direction, of fine movement stage WFS1 (or WFS2) based on the measurement values of the three Z heads 76a to 76c.

Second measurement head group 73 has an X head 77x that configures an X liner encoder 55 (see FIG. 7), a pair of Y heads 77ya and 77yb that configure a pair of Y linear encoders 56 and 57 (see FIG. 7), and three Z heads 78a, 78b and 78c that configure a surface position measuring system 58 (see FIG. 7). The respective positional relations of the pair of Y heads 77ya and 77yb and the three Z heads 78a to 78c with X head 77x serving as a reference are similar to the respective positional relations described above of the pair of Y heads 75ya and 75yb and the three Z heads 76a to 76c with X head 75x serving as a reference. An irradiation point (detection point), on grating RG, of the measurement beam irradiated from X head 77x coincides with the detection center of primary alignment system AL1. More specifically, the measurement center of X head 77x and the substantial measurement center of the two Y heads 77ya and 77yb coincide with the detection center of primary alignment system AL1. Consequently, main controller 20 can perform measurement of positional information within the XY plane and surface position information of fine movement stage WFS2 (or WFS1) at the detection center of primary alignment system AL1 at all times.

Incidentally, while each of X heads 75x and 77x and Y heads 75ya, 75yb, 77ya and 77yb of the embodiment has the light source, the photodetection system (including the photodetector) and the various types of optical systems that are unitized and placed inside measurement bar 71, the configuration of the encoder head is not limited thereto. For example, the light source and the photodetection system can be placed outside the measurement bar. In such a case, the optical systems placed inside the measurement bar, and the light source and the photodetection system are connected to each other via, for example, an optical fiber or the like. Further, a configuration can also be employed in which the encoder head is placed outside the measurement bar and only a measurement beam is guided to the grating via an optical fiber placed inside the measurement bar. Further, the rotational information of the wafer in the θz direction can be measured using a pair of the X liner encoders (in this case, there should be one Y linear encoder). Further, the surface position information of the fine movement stage can be measured using, for example, an optical interferometer. Further, instead of the respective heads of first measurement head group 72 and second measurement head group 73, three encoder heads in total, which include at least one XZ encoder head whose measurement directions are the X-axis direction and the Z-axis direction and et least one YZ encoder head whose measurement directions are the Y-axis direction and the Z-axis direction, can be arranged in the placement similar to that of the X head and the pair of Y heads described earlier.

When wafer stage WST1 moves between exposure station 200 and measurement station 300 on surface plate 14A, coarse movement stage position measuring system 68A (see FIG. 7) measures positional information of coarse movement stage WCS1 (wafer stage WST1). The configuration of coarse movement stage position measuring system 68A is not limited in particular, and includes an encoder system or an optical interferometer system (it is also possible to combine the optical interferometer system and the encoder system). In the case where coarse movement stage position measuring system 68A includes the encoder system, for example, a configuration can be employed in which the positional information of coarse movement stage WCS1 is measured by irradiating a scale (e.g. two-dimensional grating) fixed (or formed) on the upper surface of coarse movement stage WCS1 with measurement beams from a plurality of encoder heads fixed to main frame BD in a suspended state along the movement course of wafer stage WST1 and receiving the diffraction light of the measurement beams. In the case where coarse movement stage measuring system 68A includes the optical interferometer system, a configuration can be employed in which the positional information of wafer stage WST1 is measured by irradiating the side surface of coarse movement stage WCS1 with measurement beams from an X optical interferometer and a Y optical interferometer that have a measurement axis parallel to the X-axis and a measurement axis parallel to the Y-axis respectively and receiving the reflected light of the measurement beams.

Coarse movement stage position measuring system 68B (see FIG. 7) has the configuration similar to coarse movement stage position measuring system 68A, and measures positional information of coarse movement stage WCS2 (wafer stage WST2). Main controller 20 respectively controls the positions of coarse movement stages WCS1 and WCS2 (wafer stages WST1 and WST2) by individually controlling coarse movement stage driving systems 62A and 62B, based on the measurement values of coarse movement stage position measuring systems 68A and 68B.

Further, exposure apparatus 100 is also equipped with a relative position measuring system 66A and a relative position measuring system 66B (see FIG. 7) that measure the relative position between coarse movement stage WCS1 and fine movement stage WFS1 and the relative position between coarse movement stage WCS2 and fine movement stage WFS2, respectively. While the configuration of relative position measuring systems 66A and 66B is not limited in particular, relative position measuring systems 66A and 66B can each be configured of, for example, a gap sensor including a capacitance sensor. In this case, the gap sensor can be configured of, for example, a probe section fixed to coarse movement stage WCS1 (or WCS2) and a target section fixed to fine movement stage WFS1 (or WFS2). Incidentally, the configuration is not limited thereto, and for example, the relative position measuring system can be configured using, for example, a liner encoder system, an optical interferometer system or the like.

FIG. 7 shows a block diagram that shows input/output relations of main controller 20 that is configured of a control system of exposure apparatus 100 as the central component and performs overall control of the respective components. Main controller 20 includes a workstation (or a microcomputer) and the like, and performs overall control of the respective components of exposure apparatus 100 such as local liquid immersion device 8, surface plate driving systems 60A and 60B, coarse movement stage driving systems 62A and 62B, and fine movement stage driving systems 64A and 64B.

As it can be seen from the description so far, main controller 20 can measure the position of fine movement stages WFS1 and WFS2 in directions of six degrees of freedom by using the first measurement head group 72 of fine movement stage position measuring system 70. In this case, since the optical path lengths of the measurement beams are extremely short and also are almost equal to each other in X head 75x and Y heads 75ya and 75b included in the first measurement head group 72, the influence of air fluctuation can mostly be ignored. Accordingly, by the first measurement head group 72, positional information of fine movement stage WFS1 within the XY plane (including the θz direction) can be measured with high accuracy. Further, because the substantial detection points on the grating in the X-axis direction and the Y-axis direction by the first measurement head group 72 (X head 75x and Y heads 75ya and 75yb) and, detection points on the lower surface of fine movement stage WFS1 in the Z-axis direction by Z heads 76a to 76c coincide with the center (exposure position) of exposure area IA within the XY plane, respectively, generation of the so-called Abbe error caused by a shift within the XY plane of the detection point and the exposure position is suppressed to a substantially ignorable degree. Accordingly, by using fine movement stage position measuring system 70, main controller 20 can measure the position of fine movement stages WFS1 and WFS2 in the X-axis direction, the Y-axis direction, and the Z-axis direction with high precision, without any Abbe errors caused by a shift within the XY plane of the detection point and the exposure position.

On the other hand, because the Z position of the placement surface of grating RG is different from the surface of wafer W, the detection point of the first measurement head group 72 (X head 75x and Y heads 75ya and 75yb) is not always set at a position on the surface of wafer W which is the exposure position in the Z-axis direction parallel to the optical axis of projection optical system PL. Accordingly, in the case grating RG (in other words, fine movement stage WFS1 or WFS2) is tilted with respect to the XY plane, a position error (a kind of Abbe error, and will be referred to as a first position error in the description below) occurs according to a difference ΔZ (in other words, positional shift in the Z-axis direction of a detection point by the first measurement head group 72 and the exposure position) of the Z position of the placement surface of grating RG and the surface of wafer W, and the tilt angle of grating RG with respect to the XY plane, in between the position of fine movement stage WFS1 (or WFS2) within the XY plane computed based on the measurement values (output) of each of the encoder heads of the first measurement head group and the exposure position.

However, this position error (a position control error) can be obtained by a simple calculation using difference ΔZ, pitching amount θx, and rolling amount θy. And by setting the position of fine movement stages WFS1 and WFS2, based on positional information of the measurement values of (each of the encoder heads of) the first measurement head group 72 after correction using the first position error, the stages will not be influenced by the first position error.

Further, with the encoder head having the configuration as in (each of the encoder heads of) the first measurement head group 72 of the embodiment, the measurement values are known to have sensitivity not only to the change of position of grating RG (in other words, fine movement stage WFS1 or WFS2) with respect to a head in the measurement direction (the Y-axis direction or the X-axis direction), but also to the change of attitude in a non-measurement direction, especially in tilt directions (a θx direction and a θy direction) and a rotational direction (a θz direction) with respect to grating RG (refer to, for example, U.S. Patent Application Publication No. 2008/0094593 and U.S. Patent Application Publication No. 2008/0106722).

Therefore, in the embodiment, main controller 20 obtains (makes) correction information in the manner described below to correct measurement errors (a second measurement error) of each of the encoders caused due to a relative movement of the head and grating RG in the non-scanning direction described above, especially in the tilt directions (the θx direction and the θy direction) and rotational direction (the θz direction). Now, as an example, a making method of correction information to correct measurement errors of X head 75x will be briefly explained. Incidentally, in the case when measurement beams LBx₁ and LBx₂ previously described are actually no longer symmetric, while a measurement error also occurs by the displacement of fine movement stage WFS1 (or WFS2) in the Z-axis direction, because this error is at a level almost negligible, in the following description, measurement errors due to displacement in the non-measurement directions of fine movement stage WFS1 (or WFS2) which are the X, Y, and Z directions will not occur for the sake of in convenience. Further, in this case, the description will be made with one of fine movement stages WFS1 and WFS2, e.g. fine movement stage WFS1, being subject to measurement of positional information by X head 75x.

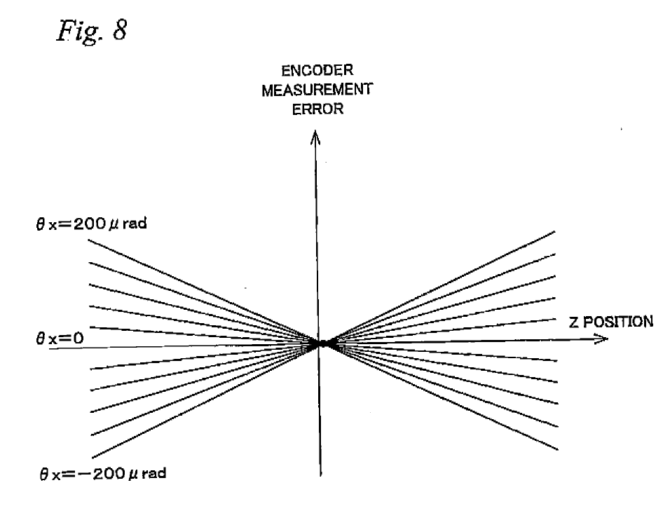

a. Main controller 20, first of all, controls coarse movement stage driving system 62A while monitoring the positional information of wafer stage WST1 using coarse movement stage position measuring system 68A, and drives fine movement stage WFS1 along with coarse movement stage WCS1 to an area where measurement by X head 75x becomes possible.
b. Next, based on an output (measurement results) of Y heads 75ya and 75yb and Z heads 76a to 76c, main controller 20 controls fine movement stage driving system 64A and sets fine movement stage WFS1 so that rolling amount θy and yawing amount θz are both zero, and that a predetermined pitching amount θx is set to a desired value θx₀ (e.g. 200 μrad).
c. Next, based on measurement results of Y heads 75ya and 75yb and Z heads 76a to 76c, main controller 20 drives fine movement stage WFS1 (WFS2) within a predetermined range, e.g. −100 μm to +100 μm, in the Z-axis direction, takes in the measurement values of X head 75x which measures the position of fine movement stage WFS1 (WFS2) in the X-axis direction at a predetermined sampling interval, and stores the measurement values in an internal memory, while controlling fine movement stage driving system 64A and maintaining the attitude (pitching amount θx=θx₀, rolling amount θy=0, and yawing amount θz=0) of fine movement stage WFS1 described above.
d. Next, main controller 20 controls fine movement stage driving system 64A based on the measurement results of Y heads 75ya and 75yb and Z heads 76a to 76c, changes the pitching amount 74 x by Δθx while keeping the rolling amount θy and yawing amount θz of fine movement stage WFS1 fixed, and then performs a processing similar to c. described above for each of the pitching amounts θx. Main controller 20 is to change pitching amount θx by Δθx within a predetermined range, e.g. −200 μrad to +200 μrad.
e. Next, each data in the internal memory obtained by the processing from b. to d. described above is plotted on a two-dimensional coordinate system whose horizontal axis indicates the Z position of fine movement stage WFS1 and the vertical axis indicates the measurement values of X head 75x. This allows a plurality of straight lines that have different slopes and intersect at a predetermined point to be obtained by joining the plotted points for each pitching amount θx. Therefore, by shifting the horizontal axis in the vertical axis direction so that the pitching amount at the intersecting point becomes zero, a graph as shown in FIG. 8 can be obtained. The value of the vertical axis of each straight line in FIG. 8 is precisely the measurement errors of X head 75x at each Z position at a pitching amount θx. Now, the Z position at the origin shall be Zₓ₀. Therefore, main controller 20 stores the measurement errors of X head 75x with respect to θx and Z in θy=θz=0 corresponding to the graph in FIG. 8 obtained by processing described above in the internal memory as θx correction information.
f. Similar to the processing b. to d. described above, main controller 20 fixes both pitching amount θx and yawing amount θz of fine movement stage WFS1 (WFS2) to zero, and changes rolling amount θy of fine movement stage WFS (WFS2). And, for each θy, fine movement stage WFS1 (WFS2) is driven in the Z-axis direction and positional information in the X-axis direction of fine movement stage WFS1 (WFS2) is measured using X head 75x. Then, by performing a processing similar to e. described above using each data obtained in the internal memory, main controller 20 stores the measurement errors of X head 75x with respect to θy and Z in θx=θz=0 corresponding to the graph in FIG. 8 which have been obtained in the internal memory as θy correction information. Now, the Z position at the origin shall be z_{y0}.
g. Similar to the processing b. to d. and f., main controller 20 obtains the measurement error of X head 75x with respect to θz and Z when θx=θy=0. Incidentally, the Z position at the origin shall be z_{z0} as in the previous description. Main controller 20 stores the measurement, errors obtained by this processing in the internal memory as θz correction information.

Incidentally, the θx correction information can be stored in memory, in a table data format consisting of discrete measurement errors of an encoder at each measurement point of pitching amount θx and the Z position. Or, a trial function of pitching amount θx and the Z position which indicates a measurement error of the encoder can be given, and an undetermined multiplier of the trial function can be determined by the least-squares method using the measurement error of the encoder. And, the trial function which has been obtained can be used as the correction information. The same can be said for θy and θz correction information.

Incidentally, the measurement errors of the encoder generally depend on all of pitching amount θx, rolling amount θy, and yawing amount θz. However, it is known that the degree of dependence is small. Accordingly, it can be regarded that the measurement error of the encoder due to the attitude change of grating RG depend on each of θx, θy and θz, independently. In other words, the measurement error (all measurement errors) of the encoder due to the attitude change of grating RG can be given, for example, in the form of formula (1) below, in a linear sum of the measurement error with respect to each of θx, θy, and θz.

Δx=Δx(Z,θx,θy,θz)=θx(Z−Zₓ₀)+θy(Z−Z_{y0})+θz(Z−Z_{z0}) (1)

Main controller 20 makes correction information (θx correction information, θy correction information, θz correction information) to correct the measurement errors of Y heads 75ya and 75yb, according to a procedure similar to the making procedure of the correction information described above. All measurement errors Δy=Δy (Z, θx, θy, θz) can be given in a similar form as in formula (1) above.

Main controller 20 performs the processing described above at the time of start-up of exposure apparatus 100, during an idle state, or at the time of wafer exchange of a predetermined number, such as, for example, a number of units, and makes the correction information (θx correction information, θy correction information, θz correction information) of X head 75x, and Y heads 75ya and 75yb described above.

Now, in exposure apparatus 100 of the embodiment, while main frame BD and base board 12 are set via a vibration isolation mechanism (not shown), for example, there is a possibility of vibration generated in various movable apparatuses which are fixed to main frame BD traveling to measurement arm 71 at the time of exposure via suspended member 74. In this case, deformation such as deflection occurs in measurement bar 71 by the vibration described above, and the optical axis of heads 75x, 75ya, and 75yb could tilt with respect to the Z-axis, or the relative distance between grating RG and heads 75x, 75ya, and 75yb could change. This is equivalent to the case when looking at heads 75x, 75ya, and 75yb with the position and attitude fixed in which a change in the tilt and the Z position of grating RG occurs, and as in a generation mechanism of the measurement errors of each encoder caused by the relative movement of the heads and grating RG in the non-measurement direction which is disclosed in, for example, U.S. Patent Application Publication No. 2008/0106722, an error could occur when measuring the position of fine movement stages WFS1 and WFS2 due to a variation (including both deformation and displacement) in measurement bar 71.

Accordingly, if the variation of the measurement bar, such as for example, a tilt due to deflection (this causes the head to tilt) can be measured, the tilt of the head can be computed based on the measurement results, and by converting the computation results to the tilt of grating RG with respect to the head, it becomes possible to use the correction information (θx correction information and θy correction information) described above in the measurement errors of each encoder caused by the variation of the measurement bar. Therefore, measuring the variation of measurement bar 71 will be described next.

In FIGS. 9A and 9B, a case is shown where a section in which the first measurement head group 72 of measurement bar 71 is installed has moved vertically (vertical vibration) in the Z-axis direction (a vertical direction), which is the simplest example of measurement arm 71 which is bent due to vibration. By the vibration described above, a deflection shown in FIG. 9A and a deflection shown in FIG. 9B repeatedly occur in measurement bar 71 periodically, which tilts the optical axis of each of the heads 75x, 75ya, and 75yb of the first measurement head group 72, periodically moving a detection point of X head 75x, and the substantial detection points of Y heads 75ya and 75yb in the +Y direction and the −Y direction with respect to the exposure position. Further, the distance in the Z-axis direction between each of the heads 75x, 75ya, and 75yb and grating RG also changes periodically.

In exposure apparatus 100 of the embodiment, main controller 20 obtains the deformation of measurement bar 71 by measuring a position (a surface position of a side surface) of housing 72₀ which houses the first measurement head group 72 shown in FIGS. 9A and 9B. In the correction of measurement errors of the first measurement head group 72 which will be described later on here, measurement errors due to vibration in the θy direction of measurement bar 71 shall not be taken into account, and only measurement errors (measurement errors due to vibration in the θx direction) at the time when a vertical vibration is generated as described above, measurement errors when the tip of measurement bar 71 vibrates (transverse vibration) in the θz direction, and measurement errors when the vertical vibration and the transverse vibration described above occur compositely shall be corrected. Therefore, displacement of measurement bar 71 in the θx direction and in the θz direction is to be measured. Incidentally, as well as this, displacement of measurement bar 71 in the θy direction can be measured, and measurement errors due to the displacement in the θy direction can be corrected, along with measurement errors due to displacement in the θx direction and the θz direction.

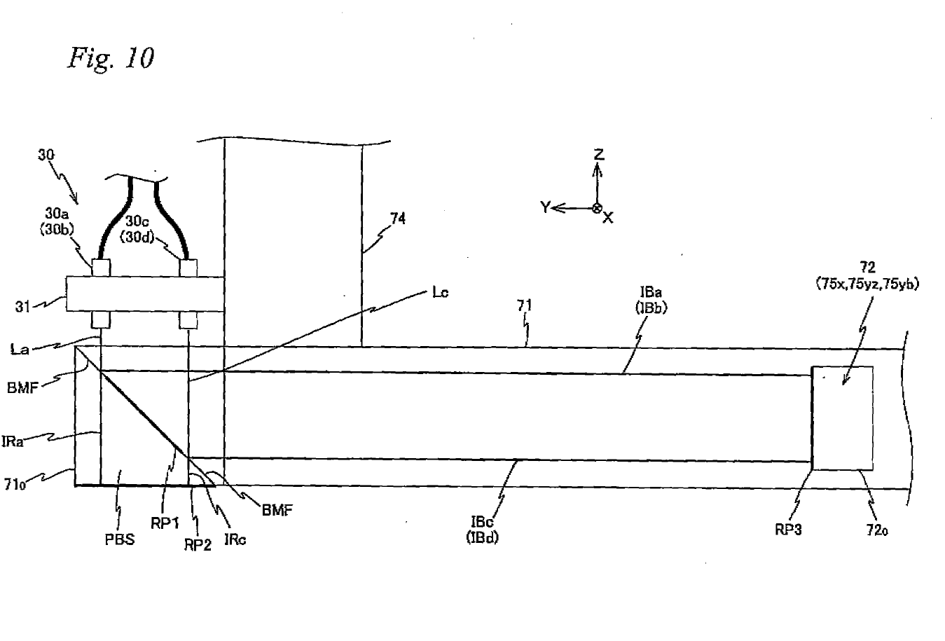

FIG. 10 shows an extracted view of a measuring system 30 (refer to FIG. 7) which measures the surface position of the side surface of housing 72₀. Measuring system 30 has four laser interferometers 30a to 30d, and of these interferometers, laser interferometers 30b and 30d are hidden behind laser interferometers 30a and 30c, in the depth of the page surface. Further, measuring system 30 has an optical member 71₀ which is fixed to the +Y end of measurement bar 71. Incidentally, measurement bar 71 is to be formed solid, except for the portion where housing 72₀ is housed.

As shown in FIG. 10, each of laser interferometers 305 to 30d is supported by support member 31 fixed to the vicinity of the lower end portion on a surface on the +Y side of suspended member 74. More specifically, on support member 31 close to an end on the −X side (the page surface in FIG. 10), laser interferometers 30a and 30c are supported spaced apart in the Y-axis direction by a predetermined distance, and in the depth of the page surface in FIG. 10 of these laser interferometers 30a and 30c, laser interferometers 30b and 30d are supported spaced apart in the Y-axis direction by a predetermined distance. Laser interferometers 30a to 30d each emits a laser beam in the −Z direction.

For example, laser beam La emitted from laser interferometer 30a is split by polarization to a reference beam IRa and a measurement beam IBa at a separation surface BMF inside optical member 71₀. Reference beam IRa is reflected off reflection surface RP2 provided on a bottom surface (a surface on the −Z end) of optical member 71₀, and returns to laser interferometer 30a via separation surface BMF. Meanwhile, measurement beam IBa passes through the solid section at the −X end side and close to the +Z end of measurement bar 71 along an optical path parallel to the Y-axis, and then reaches reflection surface RP3 formed on the −Y side end surface of measurement bar 71. Then, measurement beam IBa is reflected by reflection surface RP3, proceeds its original path in an opposite direction, and then is synthesized coaxially with reference beam IRa, and returns to laser interferometer 30a. Inside laser interferometer 30a, the polarized direction of reference beam Ma and measurement beam IBa is arranged by the polarizer, and then the beams interfere with each other to become an interference light which is detected by the photodetector (not shown), and is converted into an electric signal in accordance with the intensity of the interference light.

Laser beam Lc emitted from laser interferometer 30c is split by polarization into a reference beam IRc and a measurement beam IBc at separation surface BMF inside optical member 71₀. Reference beam IRc is reflected off reflection surface RP2, and then returns to laser interferometer 30c via separation surface BMF. Meanwhile, measurement beam IBc passes through the solid section at the −X end side and close to the −Z end of measurement bar 71 along an optical path parallel to the Y-axis, and then reaches reflection surface RP3. Then, measurement beam IBc is reflected by reflection surface RP3, proceeds its original path in an opposite direction, and then is synthesized coaxially with reference beam IRc, and returns to laser interferometer 30c. Inside laser interferometer 30c, the polarized direction of reference beam IRc and measurement beam IBc is arranged by the polarizer, and then the beams interfere with each other to become an interference light which is detected by the photodetector (not shown), and is converted into an electric signal it accordance with the intensity of the interference light.

With the remaining laser interferometers 30b and 30d, the measurement beams and the reference beams of the remaining interferometers follow the optical paths similar to laser interferometers 30a and 30c, and electrical signals in accordance with the intensity of the interference lights are output by each of their photodetectors. In this case, the optical paths of measurement beams IBb and IBd of laser interferometers 30b and 30d are placed symmetric to the optical paths of measurement beams IBa and IBc, with respect to a YZ plane which passes through the center of an XZ sectional plane of measurement bar 71. More specifically, measurement beams IBa to IBd of each of the laser interferometers 30a to 30d pass through the solid section of measurement bar 71, and are reflected off the four corners of reflection surface RP3, and then return to laser interferometers 30a to 30d following the same optical path.

Laser interferometers 30a to 30d send information in accordance with the intensity of the interference lights of each of the reflected lights of measurement beams IBa to IBd and the reference beams, respectively, to main controller 20. Based on this information, main controller 20 obtains a position (more specifically, corresponding to optical path lengths of measurement beams IBa to IBd) of the irradiation points of measurement beams IBa to IBd at each of the four corners on reflection surface RP3 that uses reflection surface RP2 as a reference. Incidentally, as laser interferometers 30a to 30d, for example, an interferometer that incorporates a reference glass can be used. Or an interferometer system that separates a laser beam output from one or two light sources, and generates measurement beams IBa to IBd can be used instead of laser interferometers 30a to 30d. In this case, optical paths of a plurality of measurement beams can be measured, using the reference beam generated from the same laser beam as a reference.

Main controller 20 obtains the surface position information (tilt angle) of reflection surface RP3, based on a change in an output of laser interferometers 30a to 30d, or more specifically, a change in the optical path length of each of the measurement beams IBa to IBd. To be more concrete, for example, in the case deformation shown in FIG. 9A occurs in measurement bar 71, the optical path lengths of measurement beams IBa and IBb of laser interferometers 30a and 30b which pass the +Z side of measurement bar 71 become longer, and the optical path lengths of measurement beams IBc and IBd of laser interferometers 30c and 30d which pass the −Z side become shorter. Further, in the case deformation shown in FIG. 9B occurs in measurement bar 71, on the contrary, the optical path lengths of measurement beams IBa and IBb become shorter, and the optical path lengths of measurement beams IBc and IBd become longer. Main controller 20 measures a tilt angle (θx, θz) with respect to the XZ plane of reflection surface RP3 as variation information, based on surface position information at each irradiation point of measurement beams IBa, IBb, IBc, and IBd on reflection surface RP3 (a surface on the −Y side of housing 72₀) measured by laser interferometers 30a to 30d. And, based on tilt angle (θx, θz), main controller 20 performs a predetermined computation and obtains a tilt angle with respect to the Z-axis of an optical axis of heads 75x, 75ya, and 75yb housed in housing 72₀ and a distance between the heads and grating RG.

In exposure apparatus 100 of the embodiment, on exposure and the like, main controller 20 obtains correction information (θx correction information, θy correction information, and θz correction information) of the second position error, while monitoring the θx, θy, θz, and Z positions of fine movement stage WFS1 (or WFS2) which are obtained from measurement results of surface position measuring system 54 of fine movement stage position measuring system 70, and computes the first position error (in other words, correction information of the position error), based on θx, θy, and difference ΔZ previously described.

Further, main controller 20 obtains variation information of measurement bar 71 measured by measuring system 30, or more specifically, obtains a tilt angle (θx, θz) with respect to the Z axis of the optical axis of heads 75x, 75ya, and 75yb, and a distance (Z) between the heads and grating RG, and based on such tilt angle and distance, obtains a measurement error of heads 75x, 75ya, and 75yb caused by the variation of measurement bar 71, or in other words, obtains correction information of a third position error. The correction information of this third position error is equivalent to tilt angle (θx, θy) with respect to the Z-axis of the optical axis of heads 75x, 75ya, and 75yb, and to θx correction information and θz correction information corresponding to distance (Z) between grating RG. Incidentally, when tilt angle θx with respect to the XZ plane of reflection surface RP3 is zero, a tilt angle with respect to the Z-axis of the optical axis of heads 75x, 75ya, and 75b does not occur ((θx, θy)=(0,0)), regardless of the value of tilt angle θz.

Then, in the manner described above, based on the correction information of the first, second, and third position errors, main controller 20 computes error correction amounts Δx and Δy used to correct the measurement values of X head 75x and Y heads 75ya and 75yb, and corrects the measurement values of X head 75x and Y heads 75ya and 75yb by the error correction amounts. Or, a target position of fine movement stage WFS1 (or WFS2) can be corrected, using error correction amounts Δx and Δy. In this manner as well, a similar effect can be obtained as in the case of correcting the measurement values of X head 75x and Y heads 75ya and 75yb of the first measurement head group 72.

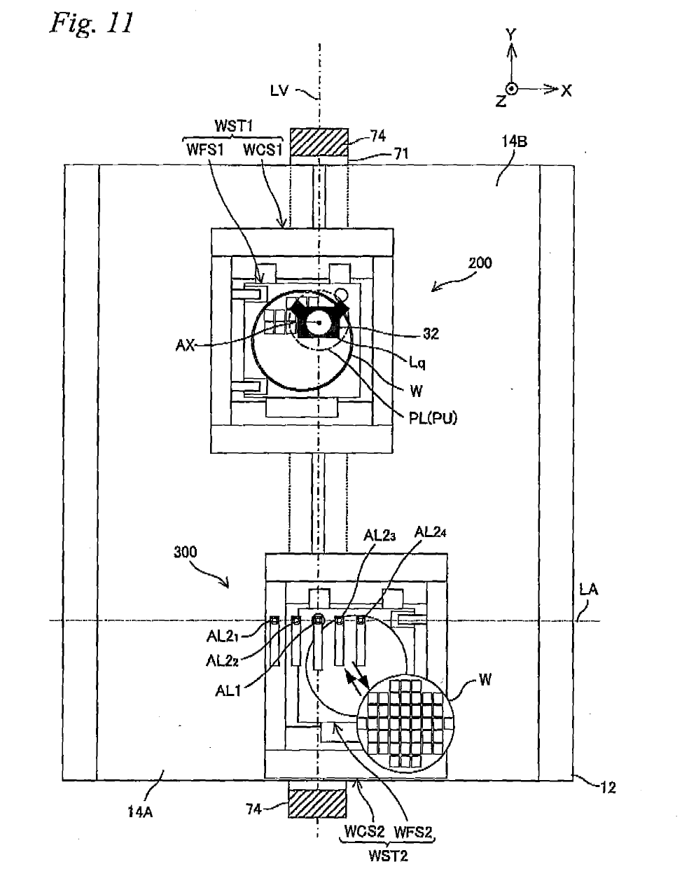

Next, a parallel processing operation using the two wafer stages WST1 and WST2 is described with reference to FIGS. 11 to 15. Note that during the operation below, main controller 20 controls liquid supply device 5 and liquid recovery device 6 as described earlier and a constant quantity of liquid Lq is held directly under tip lens 191 of projection optical system PL, and thereby a liquid immersion area is formed at all times.

FIG. 11 shows a state where exposure by a step-and-scan method is performed on wafer W mounted on fine movement stage WFS1 of wafer stage WST1 in exposure station 200, and in parallel with this exposure, wafer exchange is performed between a wafer carrier mechanism (not shown) and fine movement stage WFS2 of wafer stage WST2 at the second loading position.

Main controller 20 performs the exposure operation by a step-and-scan method by repeating an inter-shot movement (stepping between shots) operation of moving wafer stage WST1 to a scanning starting position (acceleration starting position) for exposure of each shot area on wafer W, based on the results of wafer alignment (e.g. information obtained by converting an arrangement coordinate of each shot area on wafer W obtained by an Enhanced Global Alignment (EGA) into a coordinate with the second fiducial mark on measurement plate FM1 serving as a reference) and reticle alignment and the like that have been performed beforehand, and a scanning exposure operation Of transferring a pattern formed on reticle R onto each shot area on wafer W by a scanning exposure method. During this step-and-scan operation, surface plates 14A and 14B exert the function as the countermasses, as described previously, according to movement of wafer stage WST1, for example, in the Y-axis direction during scanning exposure. Further, main controller 20 gives the initial velocity to coarse movement stage WCS1 when driving fine movement stage WFS1 in the X-axis direction for the stepping operation between shots, and thereby coarse movement stage WCS1 functions as a local countermass with respect to fine movement stage WFS1. On this operation, an initial velocity can be given to coarse movement stage WCS1 which makes the stage move in the stepping direction at a constant speed. Such a driving method is described in, for example, U.S. Patent Application Publication No 2008/0143994. Consequently, the movement of wafer stage WST1 (coarse movement stage WCS1 and fine movement stage WFS1) does not cause vibration of surface plates 14A and 14B and does not adversely affect wafer stage WST2.

The exposure operations described above are performed in a state where liquid Lq is held in the space between tip lens 191 and wafer W (wafer W and plate 82 depending on the position of a shot area), or more specifically, by liquid immersion exposure.

In exposure apparatus 100 of the embodiment, during the series of exposure operations described above, main controller 20 measures the position of fine movement stage WFS1 using the first measurement head group 72 of fine movement stage position measuring system 70, as well as computes error correction amounts Δx and Δy previously described based on correction information of the first, second, and third position errors, and controls the position of fine movement stage WFS1 (wafer W), based on each of the measurement values of X head 75x and Y heads 75ya and 75yb of the first measurement head group 72 after correction that have been corrected by the error correction amounts. Or, by main controller 20, instead of correction of the measurement values of X head 75x and Y heads 75ya and 75yb of the first measurement head group 72, correction of a target position of fine movement stage WFS1 (or WFS2) is performed using error correction amounts Δx and Δy.

The wafer exchange is performed by unloading a wafer that has been exposed from fine movement stage WFS2 and loading a new wafer onto fine movement stage WFS2 by the wafer carrier mechanism that is not illustrated, when fine movement stage WFS2 is located at the second loading position. In this case, the second loading position is a position where the wafer exchange is performed on wafer stage WST2, and in the embodiment, the second loading position is to be set at the position where fine movement stage WFS2 (wafer stage WST2) is located such that measurement plate FM2 is positioned directly under primary alignment system AL1.

During the wafer exchange described above, and after the wafer exchange, while wafer stage WST2 stops at the second loading position, main controller 20 executes reset (resetting of the origin) of second measurement head group 73 of fine movement stage position measuring system 70, or more specifically, encoders 55, 56 and 57 (and surface position measuring system 58), prior to start of wafer alignment (and the other pre-processing measurements) with respect to the new wafer W.

When the wafer exchange (loading of the new wafer W) and the reset of encoders 55, 56 and 57 (and surface position measuring system 58) have been completed, main controller 20 detects the second fiducial mark on measurement plate FM2 using primary alignment system AL1. Then, main controller 20 detects the position of the second fiducial mark with the index center of primary alignment system AL1 serving as a reference, and based on the detection result and the result of position measurement of fine movement stage WFS2 by encoders 55, 56 and 57 at the time of the detection, computes the position coordinate of the second fiducial mark in the orthogonal coordinate system (alignment coordinate system) with reference axis LA and reference axis LV serving as coordinate axes.

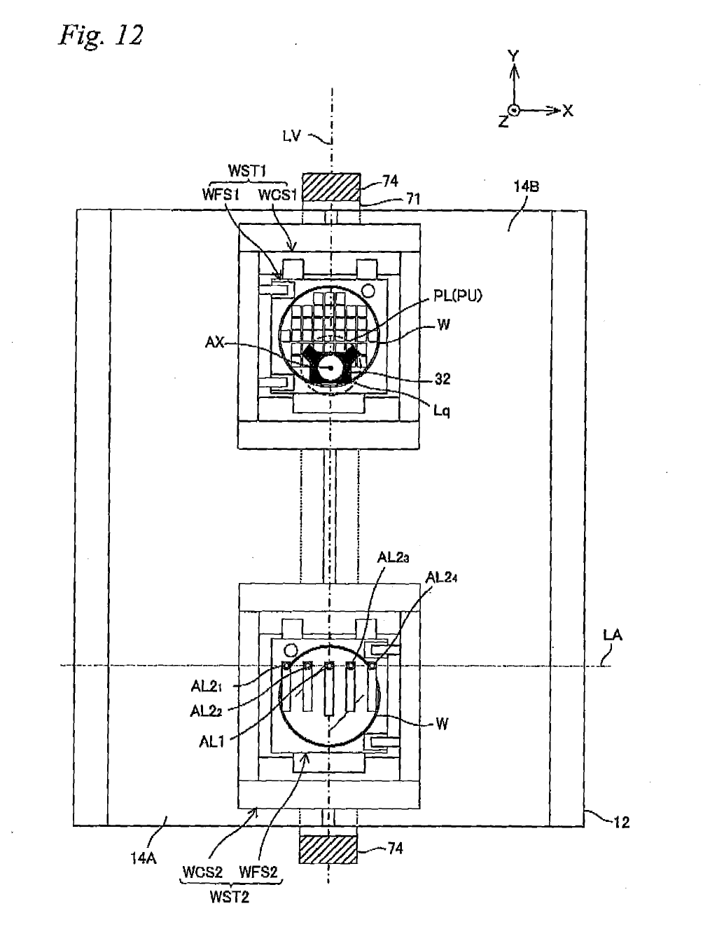

Next, main controller 20 performs the EGA while measuring the position coordinate of fine movement stage WFS2 (wafer stage WST2) in the alignment coordinate system using encoders 55, 56 and 57 (see FIG. 12). To be more specific, as disclosed in, for example, U.S. Patent Application Publication No. 2008/0088843 and the like, main controller 20 moves wafer stage WST2, or more specifically, coarse movement stage WCS2 that supports fine movement stage WFS2 in, for example, the Y-axis direction, and sets the position of fine movement stage WFS2 at a plurality of positions in the movement course, and at each position setting, detects the position coordinates, in the alignment coordinate system, of alignment marks at alignment shot areas (sample shot areas) using at least one of alignment systems AL1 and AL2₂ and AL2₄. FIG. 12 shows a state of wafer stage WST2 when the detection of the position coordinates of the alignment marks in the alignment coordinate system is performed.

In this case, in conjunction with the movement operation of wafer stage WST2 in the Y-axis direction described above, alignment systems AL1 and AL2₂ to AL2₄ respectively detect a plurality of alignment marks (sample marks) disposed along the X-axis direction that are sequentially placed within the detection areas (e.g. corresponding to the irradiation areas of detection light). Therefore, on the measurement of the alignment marks described above, wafer stage WST2 is not driven in the X-axis direction.

Then, based on the position coordinates of the plurality of alignment marks arranged at the sample shot areas on wafer W and the design position coordinates, main controller 20 executes statistical computation (EGA computation) disclosed in, for example, U.S. Pat. No. 4,780,617 and the like, and computes the position coordinates (arrangement coordinates) of the plurality of shot areas in the alignment coordinate system.

Further, in exposure apparatus 100 of the embodiment, since measurement station 300 and exposure station 200 are spaced apart, main controller 20 subtracts the position coordinate of the second fiducial mark that has previously been detected from the position coordinate of each of the shot areas on wafer W that has been obtained as a result of the wafer alignment, thereby obtaining the position coordinates of the plurality of shot areas on wafer W with the position of the second fiducial mark serving as the origin.

Normally, the above-described wafer exchange and wafer alignment sequence is completed earlier than the exposure sequence. Therefore, when the wafer alignment has been completed, main controller 20 drives wafer stage WST2 in the +X direction to move wafer stage WST2 to a predetermined standby position on surface plate 14B. In this case, when wafer stage WST2 is driven in the +X direction, fine movement stage WFS2 moves out of a measurable range of fine movement stage position measuring system 70 (i.e. the respective measurement beams irradiated from second measurement head group 73 move off from grating RG). Therefore, based on the measurement values of fine movement stage position measuring system 70 (encoders 55, 56 and 57) and the measurement values of relative position measuring system 66S, main controller 20 obtains the position of coarse movement stage WCS2, and afterward, controls the position of wafer stage WST2 based on the measurement values of coarse movement stage position measuring system 68B. More specifically, position measurement of wafer stage WST2 within the KY plane is switched from the measurement using encoders 55, 56 and 57 to the measurement using coarse movement stage position measuring system 68B. Then, main controller 20 makes wafer stage WST2 wait at the predetermined standby position described above until exposure on wafer W on fine movement stage WFS1 is completed.

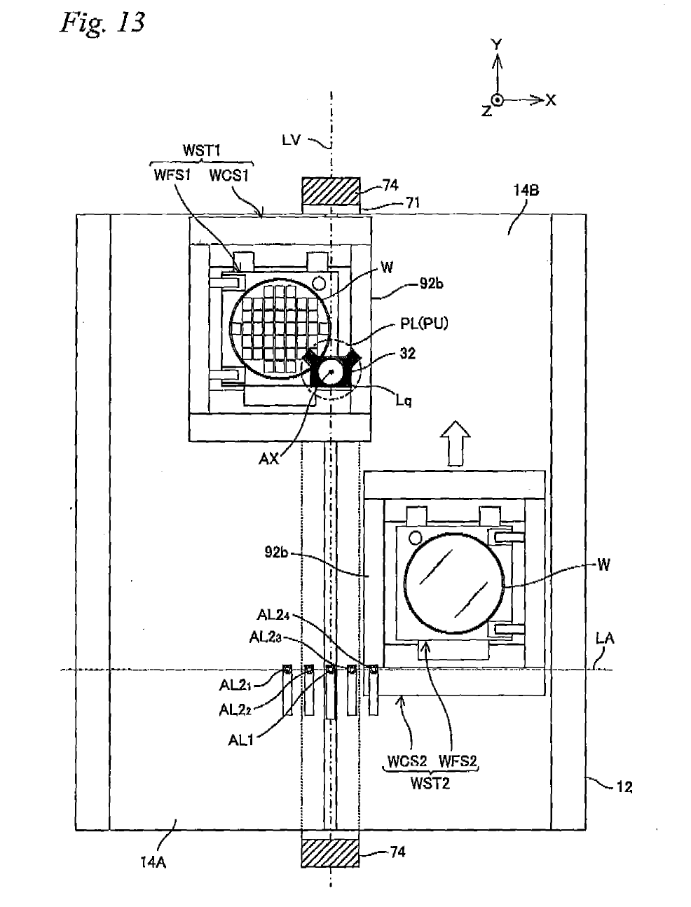

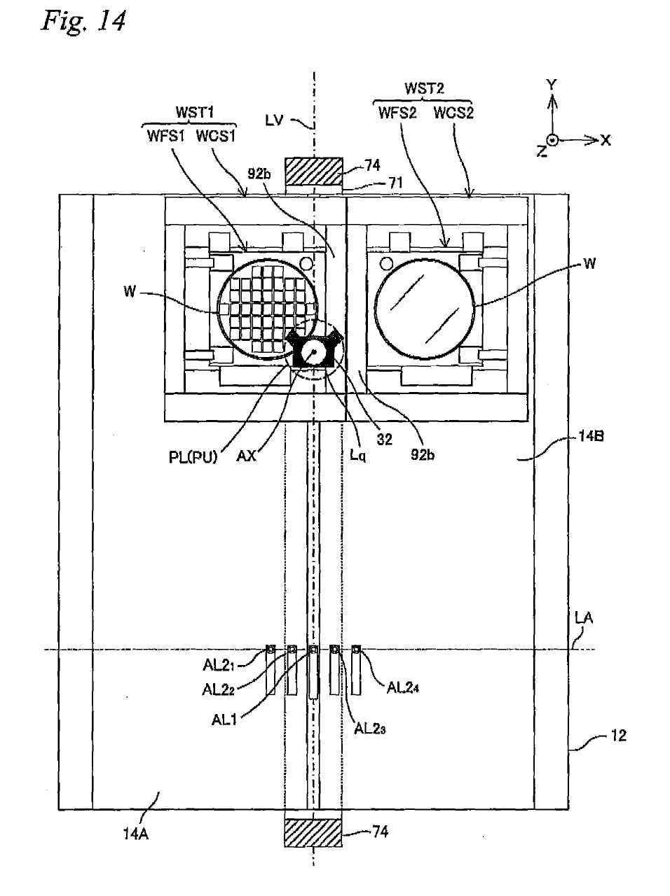

When the exposure on wafer W on fine movement stage WFS1 has been completed, main controller 20 starts to drive wafer stages WST1 and WST2 severally toward a right-side scrum position shown in FIG. 14. When wafer stage WST1 is driven in the −X direction toward the right-side scrum position, fine movement stage WFS1 moves out of the measurable range of fine movement stage position measuring system 70 (encoders 51, 52 and 53 and surface position measuring system 54) (i.e. the measurement beams irradiated from first measurement head group 72 move off from grating RG). Therefore, based on the measurement values of fine movement stage position measuring system 70 (encoders 51, 52 and 53) and the measurement values of relative position measuring system 66A, main controller 20 obtains the position of coarse movement stage WCS1, and afterward, controls the position of wafer stage WST1 based on the measurement values of coarse movement stage position measuring system 68A. More specifically, main controller 20 switches position measurement of wafer stage WST1 within the XY plane from the measurement using encoders 51, 52 and 53 to the measurement using coarse movement stage position measuring system 68A. During this operation, main controller 20 measures the position of wafer stage WST2 using coarse movement stage position measuring system 68B, and based on the measurement result, drives wafer stage WST2 in the +Y direction (see an outlined arrow in FIG. 13) on surface plate 14B, as shown in FIG. 13. By the action of a reaction force of this drive force of wafer stage WST2, surface plate 14B functions as the countermass.

Further, in parallel with the movement of wafer stages WST1 and WST2 toward the right-side scrum position described above, main controller 20 drives fine movement stage WFS1 in the +X direction based on the measurement values of relative position measuring system 66A and causes fine movement stage WFS1 to be in proximity to or in contact with coarse movement stage WCS1, and also drives fine movement stage WFS2 in the −X direction based on the measurement values of relative position measuring system 66B and causes fine movement stage WFS2 to be in proximity to or in contact with coarse movement stage WCS2.

Then, in a state where both wafer stages WST1 and WST2 have moved to the right-side scrum position, wafer stage WST1 and wafer stage WST2 go into a scrum state of being in proximity or in contact in the X-axis direction, as shown in FIG. 14. Simultaneously with this state, fine movement stage WFS1 and coarse movement stage WCS1 go into a scrum state, and coarse movement stage WCS2 and fine movement stage WFS2 go into a scrum state. Then, the upper surfaces of fine movement stage WFS1, coupling member 92b of coarse movement stage WCS1, coupling member 92b of coarse movement stage WCS2 and fine movement stage WFS2 form a fully flat surface that is apparently integrated.

As wafer stages WST1 and WST2 move in the −X direction while the three scrum states described above are kept, the liquid immersion area (liquid Lq) formed between tip lens 191 and fine movement stage WFS1 sequentially moves onto (is delivered to) fine movement stage WFS1, coupling member 92b of coarse movement stage WCS1, coupling member 92b of coarse movement stage WCS2, and fine movement stage WFS2. FIG. 14 shows a state just before starting the movement (delivery) of the liquid immersion area (liquid Lq). Note that in the case where wafer stage WST1 and wafer stage WST2 are driven while the above-described three scrum states are kept, it is preferable that a gap (clearance) between wafer stage WST1 and wafer stage WST2, a gap (clearance) between fine movement stage WFS1 and coarse movement stage WCS1 and a gap (clearance) between coarse movement stage WCS2 and fine movement stage WFS2 are set such that leakage of liquid Lq is prevented or restrained. In this case, the proximity includes the case where the gap (clearance) between the two members in the scrum state is zero, or more specifically, the case where both the members are in contact.

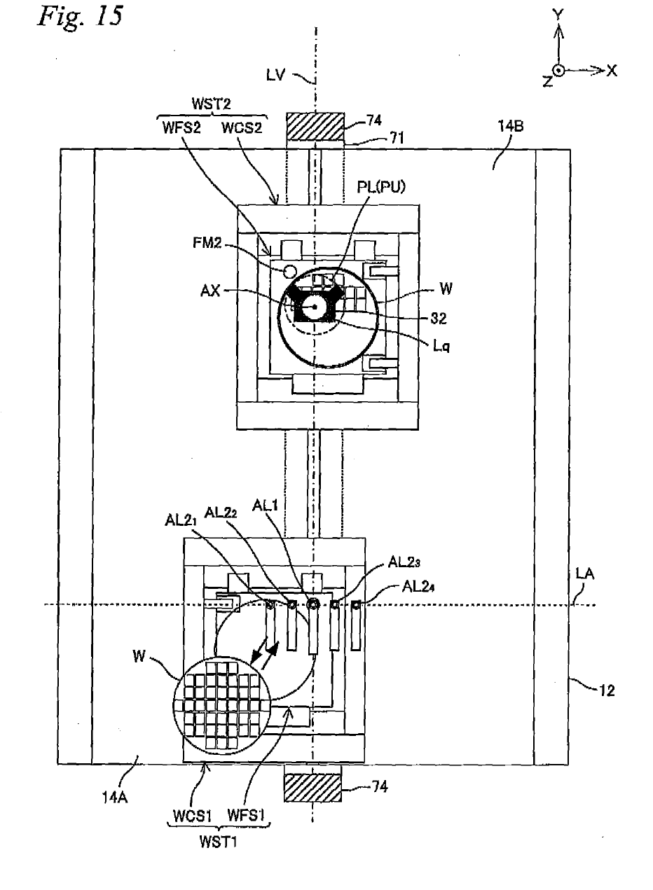

When the movement of the liquid immersion area (liquid Lq) onto fine movement stage WFS2 has been completed, wafer stage WST1 has moved onto surface plate 14A. Then, main controller 20 moves wafer stage WST1 in the −Y direction and further in the +X direction on surface plate 14A, while measuring the position of wafer stage WST1 using coarse movement stage position measuring system 68A, so as to move wafer stage WST1 to the first loading position shown in FIG. 15. In this case, on the movement of wafer stage WST1 in the −Y direction, surface plate 14A functions as the countermass owing to the action of a reaction force of the drive force. Further, when wafer stage WST1 moves in the direction, surface plate 14A can be made to function as the countermass owing to the action of a reaction force of the drive force. After wafer stage WST1 has reached the first loading position, main controller 20 switches position measurement of wafer stage WST1 within the XY plane from the measurement using coarse movement stage position measuring system 68A to the measurement using encoders 55, 56 and 57.

In parallel with the movement of wafer stage WST1 described above, main controller 20 drives wafer stage WST2 and sets the position of measurement plate FM2 at a position directly under projection optical system PL. Prior to this operation, main controller 20 has switched position measurement of wafer stage WST2 within the XY plane from the measurement using coarse movement stage position measuring system 68B to the measurement using encoders 51, 52 and 53. Then, the pair of first fiducial marks on measurement plate FM2 are detected using reticle alignment systems RA₁ and RA₂ and the relative position of projected images, on the wafer, of the reticle alignment marks on reticle R that correspond to the first fiducial marks are detected. Note that this detection is performed via projection optical system PL and liquid Lq that forms the liquid immersion area.

Based on the relative positional information detected as above and the positional information of each of the shot areas on wafer W with the second fiducial mark on fine movement stage WFS2 serving as a reference that has been previously obtained, main controller 20 computes the relative positional relation between the projection position of the pattern of reticle R (the projection center of projection optical system PL) and each of the shot areas on wafer W mounted on fine movement stage WFS2. While controlling the position of fine movement stage WFS2 (wafer stage WST2) based on the computation results, main controller 20 transfers the pattern of reticle R onto each shot area on wafer W mounted on fine movement stage WFS2 by a step-and-scan method, which is similar to the case of wafer W mounted on fine movement stage WFS1 described earlier. FIG. 15 shows a state where the pattern of reticle R is transferred onto each shot area on wafer W in this manner.

In parallel with the above-described exposure operation on wafer W on fine movement stage WFS2, main controller 20 performs the wafer exchange between the wafer carrier mechanism (not illustrated) and wafer stage WST1 at the first loading position and mounts a new wafer W on fine movement stage WFS1. In this case, the first loading position is a position where the wafer exchange is performed on wafer stage WST1, and in the present embodiment, the first loading position is to be set at the position where fine movement stage WFS1 (wafer stage WST1) is located such that measurement plate FM1 is positioned directly under primary alignment system AL1.

Then, main controller 20 detects the second fiducial mark on measurement plate FM1 using primary alignment system AL1. Note that, prior to the detection of the second fiducial mark, main controller 20 executes reset (resetting of the origin) of second measurement head group 73 of fine movement stage position measuring system 70, or more specifically, encoders 55, 56 and 57 (and surface position measuring system 58), in a state where wafer stage WST1 is located at the first loading position. After that, main controller 20 performs wafer alignment (EGA) using alignment systems AL1 and AL2₁ to AL2₄, which is similar to the above-described one, with respect to wafer W on fine movement stage WFS1, while controlling the position of wafer stage WST1.

When the wafer alignment (EGA) with respect to wafer W on fine movement stage WFS1 has been completed and also the exposure on wafer W on fine movement stage WFS2 has been completed, main controller 20 drives wafer stages WST1 and WST2 toward a left-side scrum position. This left side scrum position refers to a position in which wafer stages WST1 and WST2 are located at positions symmetrical with respect to reference axis LV previously described with the right side scrum position shown in FIG. 14. Measurement of the position of wafer stage WST1 during the drive toward the left-side scrum position is performed in a similar procedure to that of the position measurement of wafer stage WST2 described earlier.

At this left-side scrum position as well, wafer stage WST1 and wafer stage WST2 go into the scrum state described earlier, and concurrently with this state, fine movement stage WFS1 and coarse movement stage WCS1 go into the scrum state and coarse movement stage WCS2 and fine movement stage WFS2 go into the scrum state. Then, the upper surfaces of fine movement stage WFS1, coupling member 92b of coarse movement stage WCS1, coupling member 92b of coarse movement stage WCS2 and fine movement stage WFS2 form a fully flat surface that is apparently integrated.

Math controller 20 drives wafer stages WST1 and WST2 in the +X direction that is reverse to the previous direction, while keeping the three scrum states described above. According this drive, the liquid immersion area (liquid Lq) formed between tip lens 191 and fine movement stage WFS2 sequentially moves onto fine movement stage WFS2, coupling member 92b of coarse movement stage WCS2, coupling member 92b of coarse movement stage WCS1 and fine movement stage WFS1, which is reverse to the previously described order. As a matter of course, also when the wafer stages are moved while the scrum states are kept, the position measurement of wafer stages WST1 and WST2 is performed, similarly to the previously described case. When the movement of the liquid immersion area (liquid Lq) has been completed, main controller 20 starts exposure on wafer W on wafer stage WST1 in the procedure similar to the previously described procedure. In parallel with this exposure operation, main controller 20 drives wafer stage WST2 toward the second loading position in a manner similar to the previously described manner, exchanges wafer W that has been exposed on wafer stage WST2 with a new wafer W, and executes the wafer alignment with respect to the new wafer W.

After that, main controller 20 repeatedly executes the parallel processing operations using wafer stages WST1 and WST2 described above.

As described above, in exposure apparatus 100 of the embodiment, during the exposure operation and during the wafer alignment (mainly, during the measurement of the alignment marks), first measurement head group 72 and second measurement head group 73 fixed to measurement bar 71 are respectively used in the measurement of the positional information (the positional information within the XY plane and the surface position information) of fine movement stage WFS1 (or WFS2) that holds wafer W. And, since encoder heads 75x, 75ya and 75yb and Z heads 76a to 76c that configure first measurement head group 72, and encoder heads 77x, 77ya and 77yb and Z heads 78a to 78c that configure second measurement head group 73 can irradiate grating RG placed on the bottom surface of fine movement stage WFS1 and WFS2 with measurement beams from directly below at the shortest distance, measurement error caused by temperature fluctuation of the surrounding atmosphere of wafer stage WST1 or WST2, e.g., air fluctuation is reduced, and high-precision measurement of the positional information of fine movement stage WFS can be performed.

Further, first measurement head group 72 measures the positional information within the XY plane and the surface position information of fine movement stage WFS1 (or WFS2) at the point that substantially coincides with the exposure position that is the center of exposure area IA on wafer W, and second measurement head group 73 measures the positional information within the XY plane and the surface position information of fine movement stage WFS2 (or WFS1) at the point that substantially coincides with the center of the detection area of primary alignment system AL1. Consequently, occurrence of the so-called Abbe error caused by the positional error within the XY plane between the measurement point and the exposure position is restrained, and also in this regard, high-precision measurement of the positional information of fine movement stages WFS1 and WFS2 can be performed.

Further, at the time of exposure, main controller 20 measures the position of fine movement stage WFS1 using the first measurement head group 72 of fine movement stage position measuring system 70, as well as computes error correction amounts Δx and Δy previously described based on correction information of the first, second, and third position errors, and controls the position of fine movement stage WFS1 (wafer W), based on each of the measurement values of X head 75x and Y heads 75ya and 75yb of the first measurement head group 72 after correction that have been corrected by the error correction amounts. Or, by main controller 20, instead of correction of the measurement values of X head 75x and Y heads 75ya and 75yb of the first measurement head group 72, correction of a target position of fine movement stage WFS1 (or WFS2) is performed using error correction amounts Δx and Δy. Consequently, it becomes possible to drive fine movement stage WFS1 (or WFS2) with high precision, without being affected by the position error clue to the tilt of fine movement stage WFS1 (or WFS2), measurement error (position error) of X head 75x and Y heads 75ya and 75yb due to the θz rotation of fine movement stage WFS1 (or WFS2), measurement error (position error) of X head 75x and Y heads 75ya and 75yb due to the variation of the measurement bar. The position error due to the tilt of fine movement stage WFS1 (or WFS2) includes difference ΔZ of the Z position between the placement surface of grating RG and the surface of wafer W, position errors (a kind of Abbe error) according to the tilt angle with respect to the XY plane of grating RG, and measurement errors of X head 75x and Y heads 75ya and 75yb due to the relative movement of the head and grating RG in the tilt direction (θx direction, θy direction) which is the non-measurement direction. Incidentally, also with respect to (each of the encoders of) the second measurement head group 73, the measurement values of X head 75x and Y heads 75ya and 75yb can be similarly corrected so as to correct the measurement errors previously described in the non-measurement direction, especially in the tilt direction (θx direction, θy direction) of X head 75x and Y heads 75ya and 75yb due to the relative movement of the heads and grating RG, and the measurement errors due to the variation of measurement bar 71.

Further, according to exposure apparatus 100 of the embodiment, main controller 20 can drive fine movement stages WFS1 and WFS2 with good precision, based on highly precise measurement results of positional information of fine movement stages WFS1 and WFS2. Accordingly, main controller 20 can drive wafer W mounted on fine movement stages WFS1 and WFS2 in sync with reticle stage RST (reticle R) with good precision, and can transfer a pattern of reticle R on wafer W with good precision by scanning exposure.

Incidentally, in the embodiment above, the case has been described where main controller 20 corrects measurement errors in the non-measurement direction of grating RG (more specifically, fine movement stage WFS) especially measurement errors occurring due to the displacement of each of the heads in the tilt (θx, θy) and rotational (θz) directions, along with position errors (the first position error, a kind of Abbe error) corresponding to the tilt of grating RG with respect to the XY plane caused due to difference ΔZ that are included in the measurement values of each encoder of the first measurement head group 72 on exposure. However, because the second and third position errors are smaller than the first position error which is a kind of Abbe error, the correction can be performed on only the first position error, or the first position error and one of the second and third position errors.

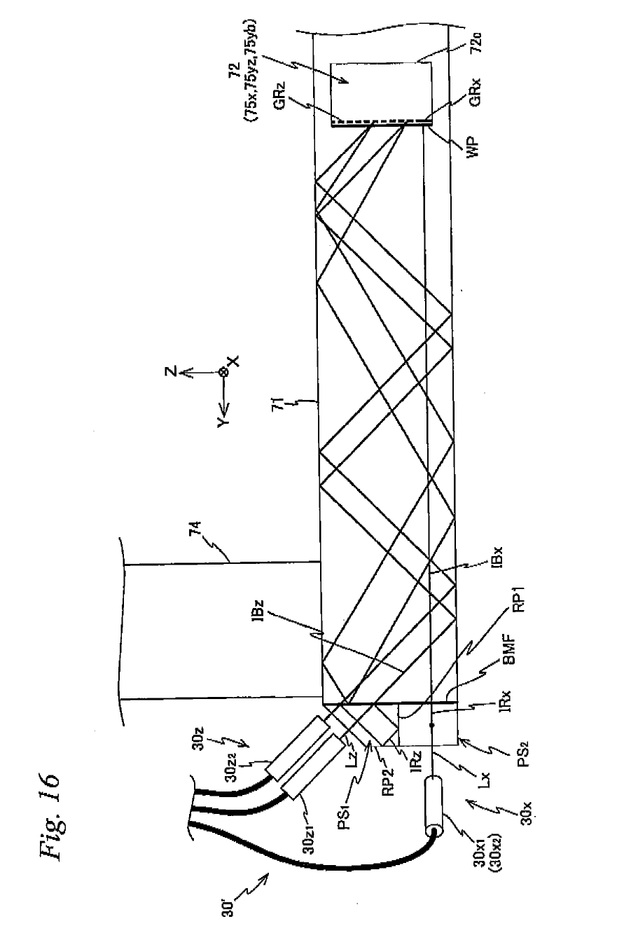

Incidentally, in the embodiment above, while the deformation (variation) of measurement bar 71 was measured by measuring the surface position of the side surface of housing 72₀ using measuring system 30, the deformation (variation) of measurement bar 71 can be measured otherwise. FIG. 16 shows a measuring system 30′ used for measurement related to a modified example which can be employed instead of measuring system 30 in the embodiment above. Measuring system 30′ measures deformation (variation) of measurement bar 71 by measuring displacement (displacement in a direction (the Z-axis direction and the X-axis direction) parallel to the edge surface) of housing 72₀ on the −Y side edge surface.

Measuring system 30′ includes two encoders 30z and 30x. As shown in FIG. 16, encoder 30z includes a light source 30z₁, a light receiving element 30z₂, an optical member PS₁, a separation surface BMF, a quarter wavelength plate (a λ/4 plate) WP, and a diffraction grating GRz.

On the +Y side in the vicinity of the lower end section of suspended member 74, light source 30z₁ and light receiving element 30z₂ are placed in a state where the longitudinal direction is parallel to the YZ plane, respectively, and also form an angle of 45 degrees with respect to the XY plane and the XZ plane, respectively. Light source 30z₁ and light receiving element 30z₂ are fixed to a main frame BD, via a support member (not shown). Optical member PS₁ is fixed to the upper half (+Z side half) of the edge surface on the +Y side of measurement bar 71 via separation surface BMF. Optical member PS₁ has a trapezoidal YZ section (a cross section perpendicular to the X-axis) as shown in FIG. 16, and is a hexahedral member that has a predetermined length in the X-axis direction. An oblique plane of optical Member PS₁ faces light source 30z₁ and light receiving element 30z₂. Grating GRz is a reflection diffraction grating whose periodic direction is in the Z-axis direction, and is provided in a remaining section except for a strip-shaped section at the end on the −Z side of the +Y edge surface of housing 72₀. In the strip-shaped section at the end on the −Z side of the +Y edge surface of housing 72₀, a reflection diffraction grating GRx to be described later and whose periodic direction is in the X-axis direction is provided. λ/4 plate WP is fixed to +Y side of diffraction gratings GRz and GRx in a state covering these diffraction gratings.

In encoder 30z, a laser beam Lz is emitted from light source 30z₁ perpendicularly with respect to an oblique plane of optical member PS₁, and laser beam Lz enters optical member PS₁ from the oblique plane, passes through the inside and then is incident on separation surface BMF. Laser beam Lz is split by polarization into a reference beam IRz and a measurement beam IBz at separation surface BMF.

Inside optical member PS₁, reference beam IRz is sequentially reflected by a −Z side surface (reflection surface RP1) and a +Y side surface (reflection surface PR2) of optical member PS₁, and by separation surface BMF, and then returns to light receiving element 30Z₂.

Meanwhile, measurement beam IBz enters measurement bar 71, passes through a solid part while being reflected by the ±Z side surfaces, and then proceeds toward the +Y end of measurement bar 71. Measurement beam IBz passes through λ/4 plate WP in the −Y direction, and then is incident on diffraction grating GRz. This generates a plurality of diffraction lights that proceed in different directions in the YZ plane (in other words, in diffraction grating GRz, measurement beam IBz is diffracted in a plurality of directions). Of the plurality of diffraction lights, for example, a diffraction light of the −1st order (measurement beam IBz diffracted in a direction of the −1st order) passes through λ/4 plate WP in the +Y direction, and passes through a solid part while being reflected by the ±Z side surfaces of measurement bar 71, and then proceeds toward the +Y end of measurement bar 71. In this case, the polarization direction of measurement beam IBz rotates by 90 degrees, by passing through λ/4 plate WP two times. Therefore, measurement beam IBz is reflected by separation surface BMF.

Measurement beam IBz that has been reflected passes through a solid part while being reflected by the ±Z side surfaces of measurement bar 71 as previously described, and then proceeds toward the +Y end of housing 72₀. Measurement beam IBz passes through λ/4 plate WP in the −Y direction, and then is incident on diffraction grating GRz. This generates a plurality of diffraction again from diffraction grating GRz (measurement beam IBz diffracts in a plurality of directions). Of the plurality of these diffraction lights, for example, a diffraction light of the −1st order (measurement beam IBz diffracted in a direction of the −1st order) passes through λ/4 plate WP in the +Y direction, and passes through a solid part while being reflected by the ±Z side surfaces of measurement bar 71, and then proceeds toward the +Y end of measurement bar 71. In this case, the polarization direction of measurement beam IBz rotates further by 90 degrees, by passing through λ/4 plate WP two times. Therefore measurement beam IBz passes through separation surface BMF.

Measurement beam IBz which has been transmitted is synthesized coaxially with reference beam IRz, and returns to light receiving element 30z₂ along with reference beam IRz. Inside light receiving element 30z₂, the polarized direction of reference beam IRz and measurement beam IBz is arranged by the polarizer, and then the beams become an interference light. This interference light is detected by a photodetector (not shown), and is converted into an electrical signal according to the intensity of the interference light.

When measurement bar 71 is deflected and the +Y edge surface of housing 72₀ is displaced in the Z-axis direction, the phase of measurement beam IBz shifts with respect to phase of reference beam IRz according to the displacement, which changes the intensity of the interference light. This change in the intensity of the interference light is supplied to main controller 20 as displacement information in the Z-axis direction of measurement bar 71 (housing 72₀). Incidentally, by the deflection of measurement bar 71, while the optical path length of measurement beam IBz changes which may cause the phase of measurement beam IBz to shift, measuring system 30′ is designed so that the shift is sufficiently smaller than the degree of phase shift which accompanies the Z displacement of measurement bar 71 (housing 72₄).

Encoder 30x includes a light source 30x₁, a photodetection device 30x₂, an optical member PS₂, a separation surface BMF, a λ/4 board WP and a diffraction grating GRx shown in FIG. 16.

On the +Y side of measurement bar 71, light source 30x₁ and light receiving element 30x₂ are placed in a state where the longitudinal direction is parallel to the YZ plane, respectively, and also form an angle of 45 degrees with respect to the XY plane and the XZ plane, respectively. Light source 30xᵢ and light receiving element 30x₂ are fixed to a main frame BD, via a support member (not shown). However, because light receiving element 30x₂ is located on the +X side (in depth of the page surface in FIG. 16) with respect to light source 30x₁, light receiving element 30x₂ is hidden behind light source 30xᵢ.

Optical member PS₂ is fixed to −Z side of optical member PS₁ of the edge surface on the +Y side of measurement bar 71 via separation surface DMF. Optical member PS₂ is a hexahedral member shaped like optical member PS₁ but is rotated around an axis parallel to the Y-axis by 90 degrees so that its oblique plane comes up front. More specifically, optical member PS₂ has a trapezoidal XY section (a cross section parallel to the Z-axis), and is a hexahedral member that has a predetermined length in the Z-axis direction. An oblique plane of optical member PS₂ faces light source 30x₁ and photodetection element 30x₂

In encoder 30x, laser beam Lx is emitted perpendicularly to an oblique plane of optical member PS₂ from light source 30x₁. Laser beam Lx enters into optical member PS₂ from the oblique plane, passes through the inside, and is split by polarization into a reference beam IRz and a measurement beam IBz at separation surface BMF.

Then, similar to reference beam IRz previously described, inside optical member PS₂, reference beam IRx is sequentially reflected by a reflection surface of optical member PS₂ on the +X side surface of optical member PS₁, a +Y reflection surface, and by separation surface BMF, and then returns to light receiving element 30x₂.

Meanwhile, measurement beam IBx enters inside measurement arm 71, passes an optical path (an optical path in the XY plane) similar to measurement beam IBz previously described, and is synthesized coaxially with reference beam IRx, and then returns to light receiving element 30x₂ along with reference beam IRx. Inside light receiving element 30x₂, the polarized direction of reference beam IRx and measurement beam IBx is arranged by the polarizer, and the beams become an interference beam. This interference light is detected by a photodetector (not shown), and is converted into an electrical signal according to the intensity of the interference light.

When measurement bar 71 is deflected and the +Y edge surface of housing 72₀ is displaced in the Z-axis direction, the phase of measurement beam IBx shifts with respect to phase of reference beam IRx according to the displacement, which changes the intensity of the interference light. This change in the intensity of the interference light is supplied to main controller 20 as displacement information in the X-axis direction of measurement bar 71 (housing 72₀). Incidentally, while the optical path length of measurement beam IBx may change by the deflection of measurement bar 71, and the phase of measurement beam IBx may shift with the change, measuring system 30′ is designed so that the degree of shift is sufficiently smaller than the degree of phase shift which occurs with the X displacement of the tip surface of measurement bar 71.

Based on the displacement information of measurement bar 71 (housing 72₀) in the Z-axis and X-axis directions supplied from encoders 30z and 30z, main controller 20 obtains the tilt angle with respect to the Z-axis of the optical axis of the heads 75x, 75ya, and 75yb provided in measurement bar 71 (housing 72₀) and the distance from grating RG, and based on the tilt angle, the distance, and the correction information previously described, correction information of measurement errors (the third position error) of each of the heads 75x, 75ya, and 75yb of the first measurement head group 72 is obtained.

Further, in the embodiment and the modified example described above, while measuring systems 30 and 30′ were described that measure variation of measurement bar 71 by an optical method, the embodiment described above is not limited to this. To measure the variation of measurement bar 71, a temperature sensor, a pressure sensor, an acceleration sensor for vibration measurement and the like can be attached to measurement bar 71. Or, a distortion sensor (distortion gauge), or a displacement sensor and the like to measure variation of measurement bar 71 can be arranged. Then, variation (deformation, displacement and the like) of measurement bar 71 (housing 72₀) is obtained with these sensors, and based on results that have been obtained, math controller 20 obtains the tilt angle with respect to the Z-axis of the optical axis of the heads 75x, 75ya, and 75yb provided in measurement bar 71 (housing 72₀) and the distance from grating RG, and based on the tilt angle, the distance, and the correction information previously described, correction information of measurement errors (the third position error) of each of the heads 75x, 75ya, and 75yb of the first measurement head group 72 is obtained. Incidentally, main controller 20 can correct the positional information obtained by coarse movement stage position measuring systems 68A and 68B, based on the variation of measurement bar 71 obtained by the sensors.

Further, in the embodiment above, while the case has been described where measurement bar 71 and main frame BD are integrated, the embodiment is not limited to this, and measurement bar 71 and main frame BD can physically be separated. In such a case, a measurement device (e.g. an encoder and/or an interferometer, or the like) that measures the position (or displacement) of measurement bar 71 with respect to main frame BD (or a reference position), and an actuator or the like that adjusts the position of measurement bar 71 should be arranged, and based on the measurement result of the measurement device, main controller 20 and/or another controller should maintain the positional relation between main frame BD (and projection optical system PL) and measurement bar 71 in a predetermined relation (e.g. constant).

Further, in the embodiment above, while the exposure apparatus has the two surface plates corresponding to the two wafer stages, the number of the surface plates is not limited thereto, and one surface plate or three or more surface plates can be employed. Further, the number of the wafer stages is not limited to two, but one wafer stage or three or more wafer stages can be employed, and a measurement stage, for example, which has an aerial image measuring instrument, an uneven illuminance measuring instrument, an illuminance monitor, a wavefront aberration measuring instrument and the like, can be placed on the surface plate, which is disclosed in, for example, U.S. Patent Application Publication No. 2007/201010.

Further, the position of the border that separates the surface plate or the base member into a plurality of sections is not limited to the position as in the embodiment above. While the border line is set as the line that includes reference axis LV and intersects optical axis AX in the embodiments above, the border line can be set at another position, for example, in the case where, if the boundary is located in the exposure station, the thrust of the planar motor at the portion where the boundary is located weakens.

Further, the mid portion (which can be arranged at a plurality of positions) in the longitudinal direction of measurement bar 71 can be supported on the base board by an empty-weight canceller as disclosed in, for example, U.S. Patent Application Publication No. 2007/0201010.

Further, the motor to drive surface plates 14A and 14B on base board 12 is not limited to the planar motor by the electromagnetic force (Lorentz force) drive method, but for example, can be a planar motor (or a linear motor) by a variable magnetoresistance drive method. Further, the motor is not limited to the planar motor, but can be a voice coil motor that includes a mover fixed to the side surface of the surface plate and a stator fixed to the base board. Further, the surface plates can be supported on the base board via the empty-weight canceller as disclosed in, for example, U.S. Patent Application Publication No. 2007/0201010 and the like. Further, the drive directions of the surface plates are not limited to the directions of three degrees of freedom, but for example, can be the directions of six degrees of freedom, only the Y-axis direction, or only the XY two-axial directions. In this case, the surface plates can be levitated above the base board by static gas bearings (e.g. air bearings) or the like. Further, in the case where the movement direction of the surface plates can be only the Y-axis direction, the surface plates can be mounted on, for example, a Y guide member arranged extending in the Y-axis direction so as to be movable in the Y-axis direction.

Further, in the embodiment above, while the grating is placed on the lower surface of the fine movement stage, i.e., the surface that is opposed to the upper surface of the surface plate, the embodiment is not limited to this, and the main section of the fine movement stage is made up of a solid member that can transmit light, and the grating can be placed on the upper surface of the main section. In this case, since the distance between the wafer and the grating is closer compared with the embodiment above, the Abbe error, which is caused by the difference in the Z-axis direction between the surface subject to exposure of the wafer that includes the exposure point and the reference surface (the placement surface of the grating) of position measurement of the fine movement stage by encoders 51, 52 and 53, can be reduced. Further, the grating can be formed on the back surface of the wafer holder. In this case, even if the wafer holder expands or the attachment position with respect to the fine movement stage shifts during exposure, the position of the wafer holder (wafer) can be measured according to the expansion or the shift.

Further, in the embodiment above, while the case has been described as an example where the encoder system is equipped with the X head and the pair of Y heads, the embodiment is not limited to this, and for example, one or two two-dimensional head(s) (2D head(s)) whose measurement directions are the two directions that are the X-axis direction and the Y-axis direction can be placed inside the measurement bar. Three modified examples of encoder system 73 configured using a 2D head will now be described.

In the case of arranging the two 2D heads, their detection points should be set at the two points that are spaced apart in the X-axis direction at the same distance from the exposure position (center (optical axis AX) of exposure area IA) as the center, on the grating. For example, a 2D head is to be placed (FIG. 5 refer to) at the setting position of Y heads 75ya and 75yb in the embodiment described above.

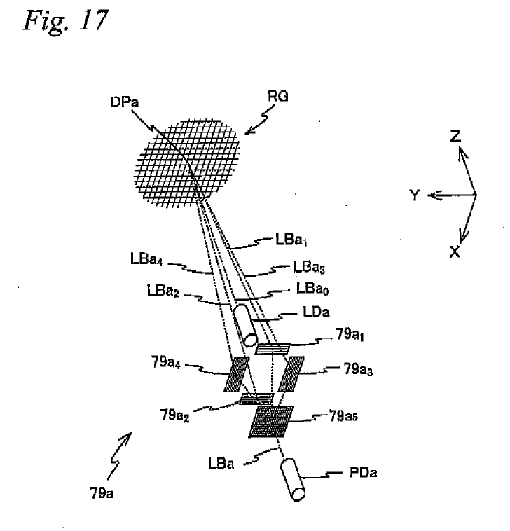

FIG. 17 shows a schematic configuration of a 2D head 79a related to a first modified example. 2D head 79a is a so-called three-grating type encoder head. 2D head 79a includes a light source LDa, fixed gratings 79a₁ to 79a₄, a two-dimensional grating (a reference grating) 79a₅, and a light receiving system PDa and the like which are placed in a predetermined positional relation. Fixed gratings 79aᵢ and 79a₂, and 79a₃ and 79a₄, here, are a transmission-type diffraction grating whose periodic direction is in the X-axis direction and the Y-axis direction, respectively. Further, two-dimensional grating (reference grating) 79a₅ is a transmission-type two-dimensional grating on which a diffraction grating having a periodic direction in the X-axis direction and a diffraction grating having a periodic direction in the Y-axis direction have been formed.

In 2D head 79a, laser beam LBa₀ is emitted from a light source LDa in the +Z direction. Laser beam LBa₀ is emitted from the upper surface (the +Z surface) of measurement arm 71 (omitted in FIG. 17) and then is irradiated on point DPa on grating RG as a measurement beam. This generates a plurality of diffraction lights from X diffraction grating and Y diffraction grating in directions corresponding to each of the periodic directions. FIG. 17 shows a +−1st order diffraction lights LBa₁ and LBa₂ generated from the X diffraction grating in a predetermined direction within the XZ plane, and a +−1st order diffraction lights LBa₃ and LBa₄ generated from the Y diffraction grating in a predetermined direction within the YZ plane.

Diffraction lights LBa₁ to LBa₄ return inside 2D head 79a via the upper surface (the +Z surface) of measurement bar 71 (omitted in FIG. 17). And diffraction lights LBa₁ to LBa₄ are diffracted by fixed gratings 79a₁ to 79a₄, respectively, and then proceed toward two-dimensional grating (reference grating) 79a₅. To be more precise, by the +1st order diffraction light LBa₁ entering fixed grating 79a₁ and the −1st order diffraction light LBa₂ entering fixed grating 79a₂, a −1st order diffraction light and a +1st order diffraction light are generated from fixed grating 79a₁ and 79a₂, respectively, at an angle of emergence symmetric to the Z-axis within the XZ plane, and these diffraction lights are incident on the same point on two-dimensional grating (reference grating) 79a₅. Further, by the +1st order diffraction light LBa₃ entering fixed grating 79a₃ and the −1st order diffraction light LBa₄ entering fixed grating 79a₄, a −1st order diffraction light and a +1st order diffraction light are generated from fixed grating 79a₃ and 79a₄, respectively, at an angle of emergence symmetric to the Z-axis within the YZ plane, and these diffraction lights are incident on the same point on two-dimensional grating (reference grating) 79a₅.

Diffraction lights LBa₁ to LBa₄ are incident on the same point on two-dimensional grating (reference grating) 79a₅, and are coaxially synthesized. To be more precise, by diffraction lights LBa₁ and LBa₂ entering two-dimensional grating 79a₅, a +1st order diffraction light and a −1st order diffraction light are generated in the Z-axis direction, respectively. Similarly, by diffraction lights LBa₃ and LBa₄ entering two-dimensional grating 79a₅, a +1st order diffraction light and a −1st order diffraction light are generated in the Z-axis direction. These diffraction lights which are generated are coaxially synthesized.

Now, a diffraction angle (angle of emergence of diffraction lights LBa₁ to LBa₄) of measurement beam LBa₀ at grating RG is uniquely decided by a wavelength of measurement beam LBa₀ and a pitch of diffraction grating of grating RG. Similarly, the diffraction angle (the bending angle of the optical path) of diffraction lights LBa₁ to LBa₄ at fixed gratings 79a₁ to 79a₄ is uniquely decided by a wavelength of measurement beam LBa₀ and a pitch of fixed gratings 79a₁ to 79a₄. Further, the diffraction angle (the bending angle of the optical path) of diffraction lights LBa₁ to LBa₄ at two-dimensional grating (reference grating) 79a₅ is uniquely decided by a wavelength of measurement beam LBa₀ and a pitch of two-dimensional grating 79a₅. Accordingly, the pitch of fixed gratings 79a₁ to 79a₄ and two-dimensional grating (reference grating) 79a₅ is decided appropriately, in accordance with the wavelength of measurement beam LBa₀ and the pitch of the diffraction grating of grating RG, so that diffraction lights LBa₁ to LBa₄ are coaxially synthesized at two-dimensional grating (reference grating) 79a₅.

Diffraction lights LBa₁ to LBa₄ (referred to as synthesized light LBa) which are coaxially synthesized is emitted in the −Z direction from two-dimensional grating 9a₅, and reaches light receiving system PDa.

Synthesized light LBa is received by a two-dimensional light receiving element such as a CCD (a quartered light receiving element) or the like. In this case, a two-dimensional Moire pattern (checkered pattern) appears on the photodetection surface of the light receiving element. This two-dimensional pattern changes in accordance with the position of grating RG in the X-axis direction and the Y-axis direction. This change is measured by the light receiving element, and the measurement results are supplied to main controller 20 as the positional information (however, irradiation point DPa of measurement beam LBa₀ is to be the measurement point) of fine movement stage WFS in the X-axis direction and the Y-axis direction.

Main controller 20 obtains positional information of fine movement stage WFS in the X-axis direction and the Y-axis direction with the center (optical axis AX) of exposure area IA serving as the substantial measurement point, from the average of the measurement results of the two 2D heads 79a. Furthermore, main controller 20 obtains positional information of fine movement stage WFS in the θz direction with the center (optical axis AX) of exposure area IA serving as the substantial measurement point, from the measurement results of the two 2D heads 79a.

Accordingly, by using the encoder system related to the first modified example, main controller 20 can constantly perform positional information measurement of fine movement stages WFS1 and WFS2 within the XY plane at the center (optical axis AX) of exposure area IA when exposing wafer W mounted on fine movement stages WFS1 and WFS2, as in the case when using the encoder system previously described.

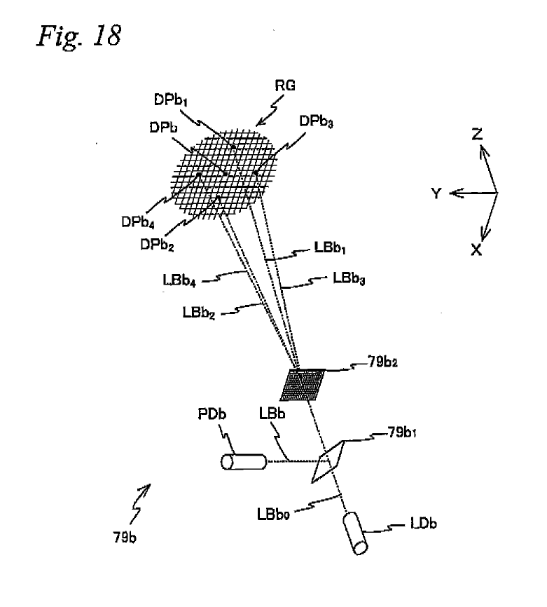

FIG. 18 shows a schematic configuration of a 2D head 79b related to a second modified example. 2D head 79b is also a three-grating type encoder head, similar to 2D head 79a related to the first modified example. 2D head 79b includes a light source LDb, a beam splitter 79b₁, a diffraction grating 79b₂, and a light receiving system PDb and the like which are placed in a predetermined positional relation. Diffraction grating 79b₂ in this case is a transmission-type two-dimensional grating on which a diffraction grating having a periodic direction in the X-axis direction and a diffraction grating that has a periodic direction in the Y-axis direction have been formed.

In 2D head 79b, laser beam LBb₀ is emitted from light source LDb in the +Z direction. Laser beam LBb₀ is incident on diffraction grating 79b₂ via beam splitter 79b₁. This generates a plurality of diffraction lights in directions corresponding to the periodic direction of diffraction grating 79b₂. FIG. 18 shows +−1st order diffraction lights LBb₁ and LBb₂ generated in symmetric directions with respect to the Z-axis from the diffraction grating whose periodic direction is in the X-axis direction, and +−1st order diffraction lights LBb₃ and LBb₄ generated in symmetric directions with respect to the Z-axis from the diffraction grating whose periodic direction is in a direction corresponding to the Y-axis direction. Diffraction lights LBb₁ to LBb₄ are emitted from the upper surface (the +Z surface) of measurement arm 71 (omitted in FIG. 18), and then are irradiated on points DPb1 to DPb₄ on grating RG as a measurement beams, respectively.

Diffraction lights LBb₁ and LBb₂, and LBb₃ and LBb₄ are diffracted by an X diffraction grating and a Y diffraction grating of grating RG, respectively, and follow the original optical path back returning to diffraction grating 79b₂ via the upper surface of measurement bar 71. Then, diffraction lights LBb₁ to LBb₄ are incident on the same point on diffraction grating 79b₂, coaxially synthesized, and then is emitted in the −Z direction. Diffraction lights LBb₁ to LBb₄ (referred to as synthesized light LBb) which are coaxially synthesized are reflected by beam splitter 79b₁, and reaches light receiving system PDb.

Now, a diffraction angle (angle of emergence of diffraction lights LBb₁ to LBb₄) of measurement beam LBb₀ at diffraction grating 79b₂ is uniquely decided by a wavelength of measurement beam LBa₀ and a pitch of diffraction grating 79b₂. Similarly, a diffraction angle (the bending angle of the optical path) of diffraction lights LBb₁ to LBb₄ at grating RG is uniquely decided by a wavelength of measurement beam LBb₀ and a pitch of the diffraction grating of grating RG. Accordingly, the pitch and setting position of diffraction grating 79b₂ are decided appropriately, in accordance with the wavelength of measurement beam LBb₀ and the pitch of the diffraction grating of grating RG, so that diffraction lights LBb₁ to LBb₄ generated at diffraction grating 79b₂ are diffracted at grating RG and then are coaxially synthesized at diffraction grating 79b₂.

Synthesized light LBb is received by a two-dimensional light receiving element such as a CCD (a quartered light receiving element) or the like. In this case, a two-dimensional Moire pattern (checkered pattern) appears on the photodetection surface of the light receiving element. This two-dimensional pattern changes in accordance with, the position of grating RG in the X-axis direction and the Y-axis direction. This change is measured by the light receiving element, and the measurement results are supplied to main controller 20 as the positional information of fine movement stage WFS in the X-axis direction and the Y-axis direction.

In this case, center DPb of irradiation points DPb₁ to DPb₄ on each grating RG of the two 2D heads 79b are at placed on the reference axis which is parallel to the X-axis and passes through the center (optical axis AX) of exposure area IA. In this case, center DPb of the two 2D heads 79b are at positions equidistant from the center (optical axis AX) of exposure area IA on the ±X side, respectively.

Main controller 20 obtains positional information of fine movement stage WFS in the X-axis direction and the Y-axis direction with the center (optical axis AX) of exposure area IA serving as the substantial measurement point, from the average of the measurement results of the two 2D heads 79b. Furthermore, main controller 20 obtains positional information of fine movement stage WFS in the θz direction with the center (optical axis AX) of exposure area IA serving as the substantial measurement point, from the measurement results of the two 2D heads 79b.

Accordingly, by using the encoder system related to the second modified example, main controller 20 can constantly perform positional information measurement of fine movement stages WFS1 and WFS2 within the XY plane at the center of exposure area IA when exposing wafer W mounted on fine movement stages WFS1 and WFS2, as in the case when using the encoder system previously described.

Incidentally, in the second modified example described above, while 2D head 79b which has a configuration including light source LDb and light receiving system PDb in the main body of the head was adopted, as well as this a 2D head 79b′ which has a configuration including light source LDb and light receiving system PDb outside of the main body of the head can also be adopted.

2D head 79b′ includes a light source LDb, a beam splitter 79b₁, a diffraction grating 79b₂, a pair of reflection surfaces 79b3 and 79b4, and a light receiving system PDb and the like which are placed in a predetermined positional relation. Light source LDb and light receiving system PDb in this case, for example, are to be provided on the +Y edge of measurement bar 71. Incidentally, measurement bar 71 is to be formed solid, except for the portion where the main body of the head is housed. Further, the pair of reflection surfaces 79b3 and 79b4 are orthogonal to a YZ plane, and are pentamirrors (or pentaprisms) that face each other at an angle of 45 degrees. Diffraction grating 79b₂ is a transmission-type two-dimensional grating on which a diffraction grating having a periodic direction in the X-axis direction and a diffraction grating that has a periodic direction in the Y-axis direction have been formed.

In 2D head 79b′, laser beam LBb₀ is emitted from light source LDb in the +Y direction. Laser beam LBb₀ travels through the solid section inside in measurement bar 71 via beam splitter 79b₁, and enters the main body of the head.

Measurement beam LBb₀ which enters the main body of the head parallel to the Y-axis is reflected by reflection surfaces 79b3 and 79b4, sequentially, and then proceeds toward diffraction grating 79b₂ parallel to the Z-axis. On the contrary, synthesized light LBb which returns in parallel with the Z-axis from diffraction grating 79b₂ is reflected by reflection surfaces 79b4 and 79b3, sequentially, and then exits the main body of the head in parallel with the Y-axis. More specifically, the measurement beam (and the synthesized light) is emitted in a direction orthogonal to the incident direction without fail, via pentamirrors 79b3 and 79b4. Therefore, for example, even if measurement bar 71 is deflected due to the weight of the arm itself or vibrates by the movement of wafer stages WST1 and WST2, because irradiation points DPb₁ to DPb₄ of diffraction lights LBb₁ to LBb₄ on grating RG do not move, this benefits in no measurement errors. Further, a similar effect can be obtained for 2D head 79a (refer to FIG. 17) related to the first modified example, by employing a configuration similar to 2D head 79b′ using pentamirrors 79b3 and 79b4.

Incidentally, in the embodiment above, while the number of the heads was one X head and two Y heads, the number of the heads can further be increased. Further, in the embodiment above, while the number of the heads per head group is one X head and two Y heads, the number of the heads can further be increased. Moreover, first measurement head group 72 on the exposure station 300 side can further have a plurality of head groups. For example, on each of the sides (the four directions that are the +X, +Y, −X and −Y directions) on the periphery of the head group placed at the position corresponding to the exposure position (a shot area being exposed on wafer W), another head group can be arranged. And, the position of the fine movement stage (wafer W) just before exposure of the shot area can be measured in a so-called read-ahead manner. Further, the configuration of the encoder system that configures fine movement stage position measuring system 70 is not limited to the one in the embodiment above and an arbitrary configuration can be employed. For example, a 3D head can also be used that is capable of measuring the positional information in each direction of the x-axis, the Y-axis and the Z-axis.

Further, in the embodiment above, the measurement beams emitted from the encoder heads and the measurement beams emitted from the Z heads are irradiated on the gratings of the fine movement stages via a gap between the two surface plates or the light-transmitting section formed at each of the surface plates. In this case, as the light-transmitting section, holes each of which is slightly larger than a beam diameter of each of the measurement beams are formed at each of surface plates 14A and 14B taking the movement range of surface plate 14A or 14B as the countermass into consideration, and the measurement beams can be made to pass through these multiple opening sections. Further, for example, it is also possible that pencil-type heads are used as the respective encoder heads and the respective Z heads, and opening sections in which these heads are inserted are formed at each of the surface plates.

Incidentally, in the embodiment above, the case has been described as an example where according to employment of the planar motors as coarse movement stage driving systems 62A and 62B that drive wafer stages WST1 and WST2, the guide surface (the surface that generates the force in the Z-axis direction) used on the movement of wafer stages WST1 and WST2 along the XY plane is formed by surface plates 14A and 14B that have the stator sections of the planar motors. However, the embodiment above is not limited thereto. Further, in the embodiment above, while the measurement surface (grating RG) is arranged on fine movement stages WFS1 and WFS2 and first measurement head group 72 (and second measurement head group 73) composed of the encoder heads (and the Z heads) is arranged at measurement bar 71, the embodiment above is not limited thereto. More specifically, reversely to the above-described case, the encoder heads (and the Z heads) can be arranged at fine movement stage WFS1 and the measurement surface (grating RG) can be formed on the measurement bar 71 side. Such a reverse placement can be applied to a stage device that has a configuration in which a magnetic levitated stage is combined with a so-called H-type stage, which is employed in, for example, an electron beam exposure apparatus, an EUV exposure apparatus or the like. In this stage device, since a stage is supported by a guide bar, a scale bar (which corresponds to the measurement bar on the surface of which a diffraction grating is formed) is placed below the stage so as to be opposed to the stage, and at least a part (such as an optical system) of an encoder head is placed on the lower surface of the stage that is opposed to the scale bar. In this case, the guide bar configures the guide surface forming member. As a matter of course, another configuration can also be employed. The place where grating RG is arranged on the measurement bar 71 side can be, for example, measurement bar 71, or a plate of a nonmagnetic material or the like that is arranged on the entire surface or at least one surface on surface plate 14A (14B).

Incidentally, in the embodiment above, since measurement bar 71 is integrally fixed to main frame BD, there is a possibility that twist or the like occurs in measurement bar 71 owing to inner stress (including thermal stress) and the relative position between measurement bar 71 and main frame BD varies. Therefore, as the countermeasure taken in such as case, it is also possible that the position of measurement bar 71 (the relative position with respect to main frame BD, or the variation of the position with respect to a reference position) is measured, and the position of measurement bar 71 is finely adjusted by an actuator or the like, or the measurement result is corrected.

Further, in the embodiment above, the case has been described where the liquid immersion area (liquid Lq) is constantly maintained below projection optical system PL by delivering the liquid immersion area (liquid Lq) between fine movement stage WFS1 and fine movement stage WFS2 via coupling members 92b that coarse movement stages WCS1 and WCS2 are respectively equipped with. However, the embodiment is not limited to this, and it is also possible that the liquid immersion area (liquid Lq) is constantly maintained below projection optical system PL by moving a shutter member (not illustrated) having a configuration similar to the one disclosed in, for example, the third embodiment of U.S. Patent Application Publication No. 2004/0211920, to below projection optical system PL in exchange of wafer stages WST1 and WST2.

Further, while the case has been described where the embodiment above is applied to stage device (wafer stages) 50 of the exposure apparatus, the embodiment is not limited to this, and the embodiment above can also be applied to reticle stage RST. Incidentally, in the embodiment above, grating RG can be covered with a protective member, e.g. a cover glass, so as to be protected. The cover glass can be arranged to cover the substantially entire surface of the lower surface of main section 80, or can be arranged to cover only a part of the lower surface of main section 80 that includes grating RG. Further, while a plate-shaped protective member is desirable because the thickness enough to protect grating RG is required, a thin film-shaped protective member can also be used depending on the material.

Besides, it is also possible that a transparent plate, on one surface of which grating RG is fixed or formed, has the other surface that is placed in contact with or in proximity to the back surface of the wafer holder and a protective member (cover glass) is arranged on the one surface side of the transparent plate, or the one surface of the transparent plate on which grating RG is fixed or formed is placed in contact with or in proximity to the back surface of the wafer holder without arranging the protective member (cover glass). Especially in the former case, grating RG can be fixed or formed on an opaque member such as ceramics instead of the transparent plate, or grating RG can be fixed or formed on the back surface of the wafer holder. In the latter case, even if the wafer holder expands or the attachment position with respect to the fine movement stage shifts during exposure, the position of the wafer holder (wafer) can be measured according to the expansion or the shift. Or, it is also possible that the wafer holder and grating RG are merely held by the conventional fine movement stage. Further, it is also possible that the wafer holder is formed by a solid glass member, and grating RG is placed on the upper surface (wafer mounting surface) of the glass member. Incidentally, in the embodiment above, while the case has been described as an example where the wafer stage is a coarse/fine movement stage that is a combination of the coarse movement stage and the fine movement stage, the embodiment is not limited to this. Further, in the embodiment above, while fine movement stages WFS1 and WFS2 can be driven in all the directions of six degrees of freedom, the embodiment is not limited to this, and the fine movement stages should be moved at least within the two-dimensional plane parallel to the XY plane. Moreover, fine movement stages WFS1 and WFS2 can be supported in a contact manner by coarse movement stages WCS1 and WCS2. Consequently, the fine movement stage driving system to drive fine movement stage WFS1 or WFS2 with respect to coarse movement stage WCS1 or WCS2 can be a combination of a rotary motor and a ball screw (or a feed screw). Incidentally, the fine movement stage position measuring system can be configured such that the position measurement can be performed in the entire area of the movement range of the wafer stages. In such a case, the coarse movement stage position measuring systems become unnecessary. Incidentally, the wafer used in the exposure apparatus of the embodiment above can be any one of wafers with various sizes, such as a 450-mm wafer or a 300-mm wafer.

Incidentally, in the embodiment above, while the case has been described where the exposure apparatus is the liquid immersion type exposure apparatus, the embodiment is not limited to this, and the embodiment above can suitably be applied to a dry type exposure apparatus that performs exposure of wafer W without liquid (water).

Incidentally, in the embodiment above, while the case has been described where the exposure apparatus is a scanning stepper, the embodiment is not limited to this, and the embodiment above can also be applied to a static exposure apparatus such as a stepper. Even in the stepper or the like, occurrence of position measurement error caused by air fluctuation can be reduced to almost zero by measuring the position of a stage on which an object that is subject to exposure is mounted using an encoder. Therefore, it becomes possible to set the position of the stage with high precision based on the measurement values of the encoder, and as a consequence, high-precision transfer of a reticle pattern onto the object can be performed. Further, the embodiment above can also be applied to a reduced projection exposure apparatus by a step-and-stitch method that synthesizes a shot area and a shot area.

Further, the magnification of the projection optical system in the exposure apparatus in the embodiment above is not only a reduction system, but also can be either an equal magnifying system or a magnifying system, and the projection optical system is not only a dioptric system, but also can be either a catoptric system or a catadioptric system, and in addition, the projected image can be either an inverted image or an erected image.

Further, illumination light IL is not limited to ArF excimer laser light (with a wavelength of 193 nm), but can be ultraviolet light such as KrF excimer laser light (with a wavelength of 248 nm), or vacuum ultraviolet light such as F₂ laser light (with a wavelength of 157 nm). As disclosed in, for example, U.S. Pat. No. 7,023,610, a harmonic wave, which is obtained by amplifying a single-wavelength laser beam in the infrared or visible range emitted by a DFB semiconductor laser or fiber laser with a fiber amplifier doped with, for example, erbium (or both erbium and ytterbium), and by converting the wavelength into ultraviolet light using a nonlinear optical crystal, can also be used as vacuum ultraviolet light.

Further, in the embodiment above, illumination light IL of the exposure apparatus is not limited to the light having a wavelength more than or equal to 100 nm, and it is needless to say that the light having a wavelength less than 100 nm can be used. For example, the embodiment above can be applied to an EUV (Extreme Ultraviolet) exposure apparatus that uses an EUV light in a soft X-ray range (e.g. a wavelength range from 5 to 15 nm). In addition, the embodiment above can also be applied to an exposure apparatus that uses charged particle beams such as an electron beam or an ion beam.

Further, in the embodiment above, a light transmissive type mask (reticle) is used, which is obtained by forming a predetermined light-shielding pattern (or a phase pattern or a light-attenuation pattern) on a light-transmitting substrate, but instead of this reticle, as disclosed in, for example, U.S. Pat. No. 6,778,257, an electron mask (which is also called a variable shaped mask, an active mask or an image generator, and includes, for example, a DMD (Digital Micromirror Device) that is a type of a non-emission type image display element (spatial light Modulator) or the like) on which a light-transmitting pattern, a reflection pattern, or an emission pattern is formed according to electronic data of the pattern that is to be exposed can also be used. In the case of using such a variable shaped mask, a stage on which a wafer, a glass plate or the like is mounted is scanned relative to the variable shaped mask, and therefore the equivalent effect to the embodiment above can be obtained by measuring the position of this stage using an encoder system.

Further, as disclosed in, for example, PCT International Publication No. 2001/035168, the embodiment above can also be applied to an exposure apparatus (a lithography system) in which line-and-space patterns are formed on wafer W by forming interference fringes on wafer W.

Moreover, the embodiment above can also be applied to an exposure apparatus that synthesizes two reticle patterns on a wafer via a projection optical system and substantially simultaneously performs double exposure of one shot area on the wafer by one scanning exposure, as disclosed in, for example, U.S. Pat. No. 6,611,316.

Incidentally, an object on which a pattern is to be formed (an object subject to exposure on which an energy beam is irradiated) in the embodiment above is not limited to a wafer, but may be another object such as a glass plate, a ceramic substrate, a film member, or a mask blank.

The usage of the exposure apparatus is not limited to the exposure apparatus used for manufacturing semiconductor devices, but the embodiment above can be widely applied also to, for example, an exposure apparatus for manufacturing liquid crystal display elements in which a liquid crystal display element pattern is transferred onto a rectangular glass plate, and to an exposure apparatus for manufacturing organic EL, thin-film magnetic heads, imaging devices (such as CCDs), micromachines, DNA chips or the like. Further, the embodiment above can also be applied to an exposure apparatus that transfers a circuit pattern onto a glass substrate, a silicon wafer or the like not only when producing microdevices such as semiconductor devices, but also when producing a reticle or a mask used in an exposure apparatus such as an optical exposure apparatus, an EUV exposure apparatus, an X-ray exposure apparatus, and an electron beam exposure apparatus.

Incidentally, the disclosures of all publications, the POT International Publications, the U.S. patent application Publications and the U.S. patents that are cited in the description so far related to exposure apparatuses and the like are each incorporated herein by reference.

Electron devices such as semiconductor devices are manufactured through the following steps: a step where the function/performance design of a device is performed; a step where a reticle based on the design step is manufactured; a step where a wafer is manufactured using a silicon material; a lithography step where a pattern of a mask (the reticle) is transferred onto the wafer with the exposure apparatus (pattern formation apparatus) of the embodiment described earlier and the exposure method thereof; a development step where the exposed wafer is developed; an etching step where an exposed member of an area other than an area where resist remains is removed by etching; a resist removing step where the resist that is no longer necessary when the etching is completed is removed; a device assembly step (including a dicing process, a bonding process, and a packaging process); an inspection step; and the like. In this case, in the lithography step, the exposure method described earlier is executed using the exposure apparatus of the embodiment above and device patterns are formed on the wafer, and therefore, the devices with high integration degree can be manufactured with high productivity.

While the above-described embodiment of the present invention is the presently preferred embodiment thereof, those skilled in the art of lithography systems will readily recognize that numerous additions, modifications, and substitutions may be made to the above-described embodiment without departing from the spirit and scope thereof. It is intended that all such modifications, additions, and substitutions fall within the scope of the present invention, which is best defined by the claims appended below.

What is claimed is:

1. An exposure apparatus that exposes an object with an energy beam via an optical system supported by a first support member, the apparatus comprising:
a movable body that holds the object and is movable along a predetermined plane;
a guide surface forming member that forms a guide surface used when the movable body moves along the predetermined plane;
a second support member that is placed apart from the guide surface forming member on a side opposite to the optical system, via the guide surface forming member, and whose positional relation with the first support member is maintained at a predetermined state;
a position measuring system which includes a first measurement member that irradiates a measurement surface parallel to the predetermined plane with a measurement beam and receives light from the measurement surface, and which obtains positional information of the movable body within the predetermined plane based on an output of the first measurement member, the measurement surface being arranged at one of the movable body and the second support member and at least a part of the first measurement member being arranged at the other of the movable body and the second support member; and
a tilt measuring system which obtains tilt information with respect to the predetermined plane of the movable body.

2. The exposure apparatus according to claim 1, the apparatus further comprising:
a driving system which drives the movable body based on positional information obtained by the position measuring system and correction information on position error due to tilt of the movable body.

3. The exposure apparatus according to claim 2, the apparatus further comprising:
a computing device which computes a first position error correction information as the correction information, based on the tilt information and a difference between a position of the measurement plane and a surface of the abject in a direction perpendicular to the predetermined plane.

4. The exposure apparatus according to claim 2, the apparatus further comprising:
a controller which makes the movable body vary in a plurality of different attitudes based on the positional information and the tilt information, obtains positional information in the predetermined plane of the movable body at different positions in a direction perpendicular to the predetermined plane while maintaining each attitude, and makes a second position error correction information according to attitude variation from a reference state of the movable body as the correction information, based on the positional information.

5. The exposure apparatus according to claim 1 wherein
the second support member is a beam-like member which is placed parallel to the predetermined plane, the apparatus further comprising:
a measuring device which measures variation information of the second support member; and
a computation device which computes a third position error correction information according to attitude variation from a reference state of the movable body, based on the variation information, whereby
the driving system drives the movable body further based on the second position error correction information.

6. The exposure apparatus according to claim 5 wherein
the beam-like member has both ends in its longitudinal direction that are fixed to the first support member in a suspended state.

7. The exposure apparatus according to claim 1 wherein
the driving system corrects a target position to drive the movable body, based on the correction information.

8. The exposure apparatus according to claim 1 wherein
the driving system corrects the positional information, based on the correction information.

9. The exposure apparatus according to claim 1 wherein
a grating whose periodic direction is in a direction parallel to the predetermined plane is placed on the measurement surface, and
the first measurement member includes an encoder head that irradiates the grating with the measurement beam and receives diffraction light from the grating.

10. The exposure apparatus according to claim 1 wherein
the guide surface forming member is a surface plate that is placed on the optical system side of the second support member so as to be opposed to the movable body and that has the guide surface parallel to the predetermined plane formed on one surface thereof on a side opposed to the movable body.

11. The exposure apparatus according to claim 10 wherein
the surface plate has a light-transmitting section through which the measurement beam can pass.

12. The exposure apparatus according to claim 10 wherein
the driving system includes a planar motor that has a mover arranged at the movable body and a stator arranged at the surface plate and drives the movable body by a drive force generated between the mover and the stator.

13. The exposure apparatus according to claim 1 wherein the measurement plane is provided at the movable body, and
at least a part of the first measurement member is placed at the second support member.

14. The exposure apparatus according to claim 13 wherein
the object is mounted on a first surface opposed to the optical system of the movable body, and the measurement surface is placed on a second surface on an opposite side of the first surface.

15. The exposure apparatus according to claim 13 wherein
the movable body includes a first movable member which is movable along the predetermined plane and a second movable member which holds the object and is supported relatively movable with the first movable member, and
the measurement surface is placed at the second movable member.

16. The exposure apparatus according to claim 15 wherein
the driving system includes a first driving system which drives the first movable member and a second driving system which relatively drives the second movable member with respect to the first movable member.

17. The exposure apparatus according to claim 13 wherein
the measuring system has one, or two or more of the first measurement members whose measurement center, which a substantial measurement axis passes through on the measurement surface, coincides with an exposure position that is a center of an irradiation area of an energy beam irradiated on the object.

18. The exposure apparatus according to claim 13, the apparatus further comprising:
a mark detecting system that detects a mark placed on the object, wherein
the measuring system has one, or two or more second measurement members whose measurement center, which a substantial measurement axis passes through on the measurement surface, coincides with a detection center of the mark detecting system.

19. An exposure apparatus that exposes an object with an energy beam via an optical system supported by a first support member, the apparatus comprising:
a movable body that holds the object and is movable along a predetermined plane;
a second support member whose positional relation with the first support member is maintained in a predetermined state;
a movable body supporting member placed between the optical system and the second support member so as to be apart from the second support member, which supports the movable body at least at two points of the movable body in a direction orthogonal to a longitudinal direction of the second support member when the movable body moves along the predetermined plane;
a position measuring system which includes a first measurement member that irradiates a measurement surface parallel to the predetermined plane with a measurement beam and receives light from the measurement surface, and which obtains positional information of the movable body within the predetermined plane based on an output of the first measurement member, the measurement surface being arranged at one of the movable body and the second support member and at least a part of the first measurement member being arranged at the other of the movable body and the second support member; and
a tilt measuring system which obtains tilt information with respect to the predetermined plane of the movable body.

20. The exposure apparatus according to claim 19, the apparatus further comprising:
a driving system which drives the movable body based on positional information obtained by the position measuring system and correction information on position error due to tilt of the movable body.

21. The exposure apparatus according to claim 19 wherein
the movable body support member is a surface plate that is placed on the optical system side of the second support member so as to be opposed to the movable body and that has a guide surface parallel to the predetermined plane formed on one surface on a side opposing to the movable body.

22. A device manufacturing method, including
exposing an object with the exposure apparatus according to claim 1; and
and developing the exposed object.

23. An exposure method in which an object is exposed with an energy beam via an optical system supported by a first support member, the method comprising:
irradiating a measurement beam on a measurement plane, which is parallel to the predetermined plane and is provided on one of the movable body and a second support member that is placed apart from a guide surface forming member forming a guide surface when the movable body moves along the predetermined plane on an opposite side of the optical system with the guide surface forming member in between and whose positional relation with the first support member is maintained at a predetermined state, and obtaining positional information of a movable body, which holds the object and is movable along a predetermined plane, at least within the predetermined plane, based on an output of a first measurement member which has at least a part of the member provided on the movable body receiving light from the measurement plane and the other of the second support member, and
driving the movable body, based on positional information of the movable body within the predetermined plane and correction information of position errors caused by a tilt of the movable body.

24. The exposure method according to claim 23, the method further comprising:
computing a first position error correction information as the correction information, based on tilt information of the movable body with respect to the predetermined plane and a difference between a position of the measurement plane and a surface of the object in a direction perpendicular to the predetermined plane.

25. The exposure method according to claim 23, the method further comprising:
obtaining positional information in the predetermined plane of the movable body at different positions in a direction perpendicular to the predetermined plane while maintaining each attitude while making the movable body vary in a plurality of different attitudes based on the positional information and the tilt information, and making a second position error correction information according to attitude variation from a reference state of the movable body as the correction information, based on the positional information.

26. The exposure method according to claim 23 wherein
the second support member is a beam-like member which is placed parallel to the predetermined plane, the method further comprising:
computing a third position error correction information according to an attitude variation of the movable body from a reference state, based on variation information of the second support member, wherein
in the driving, the movable body is driven, based further on the third position error correction information.

27. The exposure method according to claim 23 wherein
in the driving, a target position to drive the movable body is corrected, based on the correction information.

28. The exposure method according to claim 23 wherein
in the driving, the positional information is corrected, based on the correction information.

29. A device manufacturing method, including
exposing an object by the exposure method according to claim 23; and
developing the object which has been exposed.
